(19) United States
(12) Patent Application Publication
(10) Pub. No.: US 2026/0186277 A1
(43) Pub. Date: Jul. 2, 2026

(54) PROJECTION OPTICAL SYSTEM AND IMAGE PROJECTION APPARATUS

(71) Applicant: Panasonic Intellectual Property Management CO., Ltd., Osaka (JP)

(72) Inventors: Takuya IMAOKA, Kanagawa (JP); Yasushi Kobayashi, Osaka (JP); Akito Sawada, Osaka (JP)

(21) Appl. No.: 19/544,392

(22) Filed: Feb. 19, 2026

Related U.S. Application Data
(63) Continuation of application No. PCT/JP2024/034114, filed on Sep. 25, 2024.

(30) Foreign Application Priority Data
Nov. 22, 2023 (JP) 2023-198654

(51) Int. Cl. G02B 13/16; G03B 21/20

(52) U.S. Cl. CPC G02B 13/16; G03B 21/2013

(57) ABSTRACT

A projection optical system has a reduction conjugate point and a magnification conjugate point, and has an intermediate imaging position inside. The projection optical system includes: a first sub-optical system; and a second sub-optical system. The first sub-optical system includes a plurality of lenses. The second sub-optical system includes a prism. The prism includes: a first transmission surface located closest to the first sub-optical system on an optical path between the first sub-optical system and the magnification conjugate point; a second transmission surface located closest to the magnification conjugate point; and a reflective surface group including a second reflective surface located closest to the second transmission surface on the optical path between the first transmission surface and the second transmission surface. All or a part of the intermediate imaging position is present inside the prism. The second reflective surface is formed with a dielectric multilayer film including no metal layer.

### CROSS REFERENCE TO RELATED APPLICATION

This application claims benefit of priority to International Application No. PCT/JP2024/034114, with an international filing date of Sep. 25, 2024, which claims priorities of Japanese Patent Application No. 2023-198654 filed on Nov. 22, 2023, the entire contents of which are incorporated herein by reference.

### BACKGROUND

### Technical Field

The present disclosure relates to a projection optical system using a prism. The present disclosure also relates to an image projection apparatus using such a projection optical system.

### Background Art

JP 6605635 B and JP 4331290 B disclose optical systems capable of performing a short-throw and large-screen projection using a prism, and refer to providing a metal reflective film, a dielectric multilayer film, or a composite film of a metal and a dielectric multilayer film on a reflective surface of the prism.

### SUMMARY

The present disclosure provides a projection optical system capable of performing a short-throw and large-screen projection and reducing color unevenness and drift in an image. The present disclosure also provides an image projection apparatus using such a projection optical system.

An aspect of the present disclosure provides a projection optical system having a reduction conjugate point on a reduction side and a magnification conjugate point on a magnification side, and having an intermediate imaging position being conjugate with the reduction conjugate point and the magnification conjugate point inside, and the projection optical system into which red light, green light, and blue light are incident from a light source, and which projects an image, the projection optical system comprising:
a first sub-optical system; and
a second sub-optical system disposed closer to the magnification side than the first sub-optical system,
wherein
the first sub-optical system includes a plurality of lenses,
the second sub-optical system includes a prism formed of a transparent medium,
the prism includes: a first transmission surface located closest to the first sub-optical system on an optical path between the first sub-optical system and the magnification conjugate point; a second transmission surface located closest to the magnification conjugate point; and a reflective surface group including a second reflective surface located closest to the second transmission surface on the optical path between the first transmission surface and the second transmission surface,
all or a part of the intermediate imaging position is present inside the prism,
the second reflective surface is formed with a dielectric multilayer film including no metal layer, and
a reflectance of the dielectric multilayer film. is larger than 95% with respect to the blue light.

Another aspect of the present disclosure provides a projection optical system having a reduction conjugate point on a reduction side and a magnification conjugate point on a magnification side, and having an intermediate imaging position being conjugate with the reduction conjugate point and the magnification conjugate point inside, and the projection optical system into which red light, green light, and blue light are incident from a light source, and which projects an image, the projection optical system comprising:
a first sub-optical system; and
a second sub-optical system disposed closer to the magnification side than the first sub-optical system,
wherein
the first sub-optical system includes a plurality of lenses,
the second sub-optical system includes a prism formed of a transparent medium,
the prism includes: a first transmission surface located closest to the first sub-optical system on an optical path between the first sub-optical system and the magnification conjugate point; a second transmission surface located closest to the magnification conjugate point; and a reflective surface group including a second reflective surface located closest to the second transmission surface on the optical path between the first transmission surface and the second transmission surface,
all or a part of the intermediate imaging position is present inside the prism, and
the second reflective surface is formed with a coating layer that reflects both a first light ray having an incident angle at which total reflection is performed and a second light ray having an incident angle at which total reflection is not formed, and
a reflectance of the coating layer. is larger than 95% with respect to the blue light.

Another aspect of the present disclosure provides an imaging apparatus includes: an image forming element that generates an image to be projected onto a screen via the projection optical system; and a light source that supplies light to the image forming element.

According to the projection optical system of the present disclosure, it is possible to perform a short-throw and large-screen projection, and in particular, it is possible to reduce color unevenness in an image projected on a screen, and it is possible to further suppress APL (Average Picture Level) drift.

### BRIEF DESCRIPTION OF DRAWINGS

FIG. 1A is a layout diagram illustrating an optical system 1 according to a first embodiment;

FIG. 1B is a layout diagram illustrating an optical system 1 according to a first embodiment;

FIG. 2A is a layout diagram illustrating an optical system 1 according to a second embodiment;

FIG. 2B is a layout diagram illustrating an optical system 1 according to a second embodiment;

FIG. 3A is a layout diagram illustrating an optical system 1 according to a third embodiment;

FIG. 3B is a layout diagram illustrating an optical system 1 according to a third embodiment;

FIG. 4 is an explanatory diagram illustrating reflection of light inside a prism PM having two reflective surfaces R1 and R2;

FIG. 5A illustrates a reflective coating structure (comparative example) in which an enhanced reflective coating FB and a metal reflective film FA are formed and reflectance spectrum characteristics thereof;

FIG. 5B is a graph illustrating reflectance spectrum characteristics of the reflective coating of FIG. 5A;

FIG. 5C is a graph illustrating reflectance spectrum characteristics of the reflective coating of FIG. 5A;

FIG. 6A illustrates a reflective coating structure in which a dielectric multilayer film FM including no metal layer is formed and reflectance spectrum characteristics thereof;

FIG. 6B is a graph illustrating reflectance spectrum characteristics of the reflective coating of FIG. 6A;

FIG. 6C is a graph illustrating reflectance spectrum characteristics of the reflective coating of FIG. 6A;

FIG. 7 is a graph illustrating an example of reflectance spectrum characteristics of a typical dielectric multilayer film;

FIG. 8A is a graph illustrating an example of reflectance spectrum characteristics of another typical dielectric multilayer film;

FIG. 8B is a graph illustrating an example of emission spectrum characteristics of a light source used in a projection apparatus;

FIG. 8C is a definition of a ripple valley appearing in a reflectance spectrum;

FIG. 9 is an explanatory diagram illustrating shapes of footprints on a first reflective surface R1 and a second reflective surface R2 according to Examples 1 to 3;

FIG. 10A illustrates reflectance spectrum characteristics (incident angle: 0°) of a dielectric multilayer film (Table 4, 64 layers) formed on glass KVC80;

FIG. 10B illustrates reflectance spectrum characteristics (incident angle: (critical angle −5°) to (critical angle −1°)) of the same dielectric multilayer film;

FIG. 10C illustrates reflectance spectrum characteristics (incident angle: critical angle) 36.2° of the same dielectric multilayer film;

FIG. 11A illustrates reflectance spectrum characteristics (incident angle: 0°) of a dielectric multilayer film (Table 5, 54 layers) formed on glass KVC80;

FIG. 11B illustrates reflectance spectrum characteristics (incident angle: (critical angle −5°) to (critical angle −1°) of the same dielectric multilayer film;

FIG. 11C illustrates reflectance spectrum characteristics (incident angle: critical angle 36.2°) of the same dielectric multilayer film;

FIG. 12A illustrates reflectance spectrum characteristics (incident angle: 0°) of a dielectric multilayer film (Table 6, 84 layers) formed on glass KVC80;

FIG. 12B illustrates reflectance spectrum characteristics (incident angle: (critical angle −5°) to (critical angle −1°)) of the same dielectric multilayer film;

FIG. 12C illustrates reflectance spectrum characteristics (incident angle: critical angle 36.2°) of the same dielectric multilayer film;

FIG. 13A illustrates reflectance spectrum characteristics (incident angle: 0°) of a dielectric multilayer film (Table 10, 64 layers) formed on glass KSKLD5;

FIG. 13B illustrates reflectance spectrum characteristics (incident angle: (critical angle −5°) to (critical angle −1°)) of the same dielectric multilayer film;

FIG. 13C illustrates reflectance spectrum characteristics (incident angle: critical angle 39.0°) of the same dielectric multilayer film;

FIG. 14A illustrates reflectance spectrum characteristics (incident angle: 0°) of a dielectric multilayer film (Table 11, 54 layers) formed on glass KSKLD5;

FIG. 14B illustrates reflectance spectrum characteristics (incident angle: (critical angle −5°) to (critical angle −1°) of the same dielectric multilayer film;

FIG. 14C illustrates reflectance spectrum characteristics (incident angle: critical angle 39.0°) of the same dielectric multilayer film;

FIG. 15A illustrates reflectance spectrum characteristics (incident angle: 0°) of a dielectric multilayer film (Table 12, 84 layers) formed on glass KSKLD5;

FIG. 15B illustrates reflectance spectrum characteristics (incident angle: (critical angle −5°) to (critical angle −1°) of the same dielectric multilayer film;

FIG. 15C illustrates reflectance spectrum characteristics (incident angle: critical angle 39.0°) of the same dielectric multilayer film; and

FIG. 16 is a block diagram illustrating an example of an image projection apparatus according to the present disclosure.

### DETAILED DESCRIPTION

Hereinafter, embodiments will be described in detail with reference to the drawings. Unnecessarily detailed description may be omitted. For example, a detailed description of a well-known matter or a repeated description of substantially the same configuration may be omitted. This is to avoid unnecessary redundancy of the following description and to facilitate understanding of the skilled person.

The accompanying drawings and the following description are provided by the applicant for the skilled person to fully understand the present disclosure, and they are not intended to limit the subject matter described in the claims.

Hereinafter, each example of the optical system according to the present disclosure will be described. In each example, a case where the optical system is used for a projector (an example of an image projection apparatus) that projects image light of an original image SA obtained by spatially modulating incident light with an image forming element such as a liquid crystal or a digital micromirror device (DMD) based on an image signal onto a screen will be described. That is, the optical system according to the present disclosure can be used to dispose a screen (not illustrated) on the extension line on the magnification side, enlarge the original image SA on the image forming element disposed on the reduction side, and project the enlarged original image SA onto the screen. However, the projection target surface is not limited to a screen. The projection target surface also includes a wall, a ceiling, a floor, and the like of a house, a store, or in the interior of a vehicle or an airplane used as a transportation means.

### First Embodiment

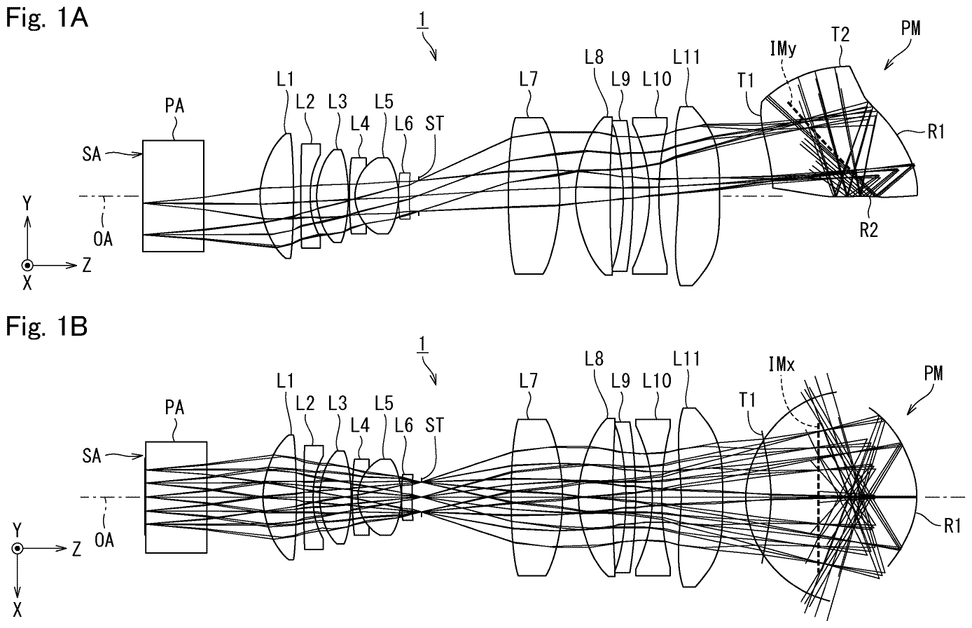

An optical system according to a first embodiment of the present disclosure will be described below with reference to FIGS. 1 to 15C.

### Example 1

FIGS. 1A and 1B are layout diagrams illustrating an optical system 1 according to Example 1. FIG. 1A is a side view illustrating a YZ plane, and FIG. 1B is a top view illustrating an XZ plane. The optical system 1 includes a first sub-optical system including a plurality of lens elements and an aperture stop ST, and a second sub-optical system including a prism PM. In FIG. 1A, a reduction conjugate point which is an imaging position on the reduction side is located on the left side of the optical axis OA, and a magnification conjugate point which is an imaging position on the magnification side is located on the upper left side of the optical axis OA. The second sub-optical system is provided on the magnification side with respect to the first sub-optical system on the optical path. When the optical system 1 is used in an image projection apparatus such as a projector, an image forming element is installed at the reduction conjugate point, and a screen is installed at the magnification conjugate point.

Intermediate imaging position that are conjugate with the reduction conjugate point and the magnification conjugate point, respectively, are located inside the optical system 1. As the intermediate imaging positions, as indicated by broken lines in FIGS. 1A and 1B, both a Y-direction intermediate image IMy and an X-direction intermediate image IMx are present inside the prism PM. All of each of the intermediate imaging positions is present inside the prism PM.

The first sub-optical system includes an optical element PA and lens elements L1 to L11 in order from the reduction side to the magnification side. The optical element PA represents an optical element such as a total internal reflection (TIR) prism, a prism for color separation and color synthesis, an optical filter, a parallel plate glass, a crystal low-pass filter, and an infrared cut filter. A reduction conjugate point is set at a position at a predetermined distance from the end surface on the reduction side of the optical element PA, and the original image SA is installed therein. In Example 1, this predetermined distance is zero, and the original image SA is directly present on the end surface on the reduction side of the optical element PA.

The optical element PA includes two transmission surfaces that are parallel and flat (S1, S2). For surface numbers, reference is made to later-described numerical examples. The lens element L1 has a biconvex shape (S3, S4). The lens element L2 has a negative meniscus shape with a convex surface facing the reduction side (S5, S6). The lens element L3 has a biconvex shape (S7, S8). The lens element L4 has a negative meniscus shape with a convex surface facing the reduction side (S9, S10). The lens element L5 has a biconvex shape (S10, S11). The lens elements L4 and L5 are joined to each other to constitute a compound lens. The lens element L6 has a negative meniscus shape with a convex surface facing the reduction side (S12, S13). The lens element L7 has a biconvex shape (S15, S16). The lens element L8 has a positive meniscus shape with a convex surface facing the reduction side (S17, S18). The lens element L9 has a negative meniscus shape with a convex surface facing the magnification side (S19, S20). The lens element L10 has a biconcave shape (S21, S22). The lens element L11 has a negative meniscus shape with a convex surface facing the magnification side (S23, S24). These lens elements L1 to L11 are rotationally symmetric lenses having a surface shape rotationally symmetric about the optical axis OA of the first sub-optical system, and portions through which light ray does not pass may be deleted as necessary.

The aperture stop ST defines a range in which the light flux passes through the optical system 1, and is positioned between the reduction conjugate point and the above-described intermediate imaging positions. As an example, the aperture stop ST is located between the lens element L6 and the lens element L7 (S14).

The second sub-optical system includes a prism PM formed of a transparent medium, for example, glass, synthetic resin, or the like. The prism PM includes, as a plurality of optical surfaces, a first transmission surface T1 located closest to the first sub-optical system on the optical path between the first sub-optical system and the magnification conjugate point, a second transmission surface T2 located closest to the magnification conjugate point on the optical path between the first sub-optical system and the magnification conjugate point, and a first reflective surface R1 located closest to the first transmission surface T1 and a second reflective surface R2 located closest to the second transmission surface T2 on the optical path between the first transmission surface T1 and the second transmission surface T2. The first reflective surface R1 and the second reflective surface R2 constitute a reflective surface group. The first transmission surface T1 has a free-form surface shape with a convex surface facing the magnification side (S25). The first reflective surface R1 has a free-form surface shape with a concave surface facing the direction in which the light ray incident on the first reflective surface R1 is reflected (S26). The second reflective surface R2 has a free-form surface shape with a convex surface facing the direction in which the light ray incident on the second reflective surface R2 is reflected (S27). The second transmission surface T2 has a free-form surface shape with a convex surface facing the magnification side (S28).

For the three-dimensional shape of the prism PM, for example, the first transmission surface T1 is curved so as to face the concave surface in the −Z direction, the second transmission surface T2 has a shape like a partial dome covering the other optical surfaces from above, the first reflective surface R1 faces the first transmission surface T1, and the second reflective surface R2 faces the second transmission surface T2.

In the prism PM, because the first transmission surface T1, the second transmission surface T2, the first reflective surface R1, and the second reflective surface R2 are integrated, assembly adjustment between optical components can be reduced, and cost can be suppressed. In addition, the optical surfaces having the power of the prism PM, for example, the first transmission surface T1, the second transmission surface T2, and the first reflective surface R1 do not have rotationally symmetric axes, that is, are formed as free-form surfaces having different curvatures in the X-axis and the Y-axis. By using a free-form surface capable of defining different curvatures in the X-axis and the Y-axis for the optical surfaces of the prism, the degree of freedom for correcting distortion satisfactorily increases, and thus, the effect of shortening the entire length of the first sub-optical system can also be expected.

A dielectric multilayer film including no metal layer is formed on both the first reflective surface R1 and the second reflective surface R2 of the prism PM or only the second reflective surface R2. A specific example of the dielectric multilayer film will be described later.

### Example 2

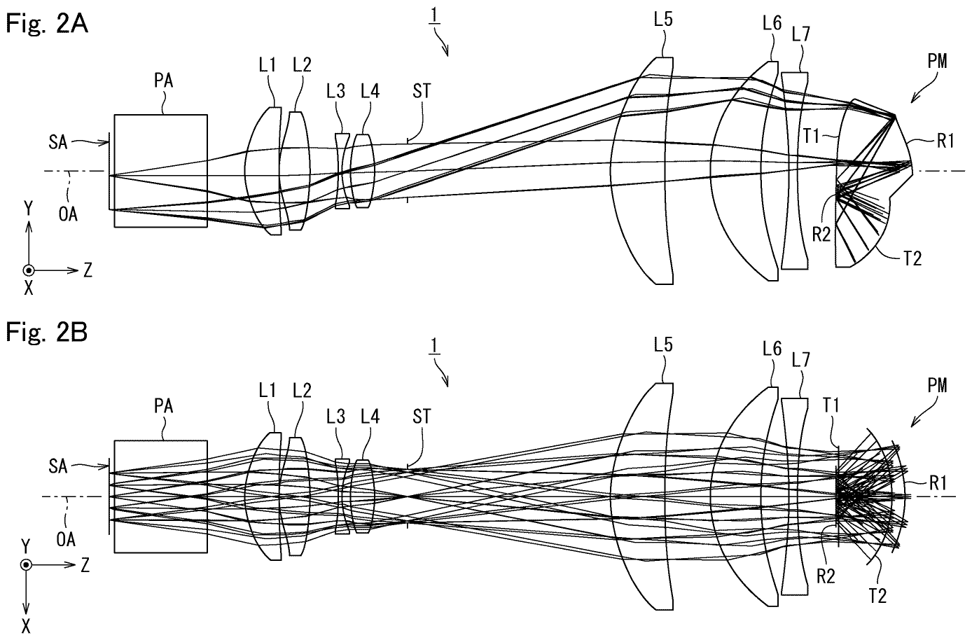

FIGS. 2A and 2B are layout diagrams illustrating the optical system 1 according to Example 2. FIG. 2A is a side view illustrating a YZ plane, and FIG. 2B is a top view illustrating an XZ plane. The optical system 1 has the same configuration as that of Example 1, and the description overlapping with that of Example 1 will be omitted. The optical system 1 includes a first sub-optical system including a plurality of lens elements and an aperture stop ST, and a second sub-optical system including a prism PM. In FIG. 2A, a reduction conjugate point which is an imaging position on the reduction side is located on the left side of the optical axis OA, and a magnification conjugate point which is an imaging position on the magnification side is located on the upper left side of the optical axis OA. The second sub-optical system is provided on the magnification side with respect to the first sub-optical system on the optical path.

Intermediate imaging positions that are conjugate with the reduction conjugate point and the magnification conjugate point, respectively, are located inside the optical system 1. As the intermediate imaging positions, both the Y-direction intermediate image IMy and the X-direction intermediate image IMx are present inside the prism PM as in FIG. 1. All of each of the intermediate imaging positions is present inside the prism PM.

The first sub-optical system includes an optical element PA and lens elements L1 to L7 in order from the reduction side to the magnification side. A reduction conjugate point is set at a position at a predetermined distance from the end surface on the reduction side of the optical element PA, and the original image SA is installed therein.

The optical element PA includes two transmission surfaces that are parallel and flat (S1, S2). For surface numbers, reference is made to later-described numerical examples. The lens element L1 has a positive meniscus shape with a convex surface facing the reduction side (S3, S4). The lens element L2 has a biconvex shape (S5, S6). The lens element L3 has a biconcave shape (S7, S8). The lens element L4 has a biconvex shape (S9, S10). The lens element L5 has a positive meniscus shape with a convex surface facing the reduction side (S13, S14). The lens element L6 has a positive meniscus shape with a convex surface facing the reduction side (S15, S16). The lens element L7 has a biconcave shape (S17, S18). These lens elements L1 to L7 are rotationally symmetric lenses having a surface shape rotationally symmetric about the optical axis OA of the first sub-optical system, and portions through which light ray does not pass may be deleted as necessary.

The aperture stop ST defines a range in which the light flux passes through the optical system 1, and is positioned between the reduction conjugate point and the above-described intermediate imaging positions. As an example, the aperture stop ST is located between the lens element L4 and the lens element L5 (S11).

The prism PM includes, as a plurality of optical surfaces, a first transmission surface T1 located closest to the first sub-optical system on the optical path between the first sub-optical system and the magnification conjugate point, a second transmission surface T2 located closest to the magnification conjugate point on the optical path between the first sub-optical system and the magnification conjugate point, and a first reflective surface R1 located closest to the first transmission surface T1 and a second reflective surface R2 located closest to the second transmission surface T2 on the optical path between the first transmission surface T1 and the second transmission surface T2. The first reflective surface R1 and the second reflective surface R2 constitute a reflective surface group. The first transmission surface T1 has a free-form surface shape with a convex surface facing the magnification side (S19). The first reflective surface R1 has a free-form surface shape with a concave surface facing the direction in which the light ray incident on the first reflective surface R1 is reflected (S20). The second reflective surface R2 has a free-form surface shape with a convex surface facing the direction in which the light ray incident on the second reflective surface R2 is reflected (S21). The second transmission surface T2 has a free-form surface shape with a convex surface facing the magnification side (S22).

A dielectric multilayer film including no metal layer is formed on both the first reflective surface R1 and the second reflective surface R2 of the prism PM or only the second reflective surface R2. A specific example of the dielectric multilayer film will be described later.

### Example 3

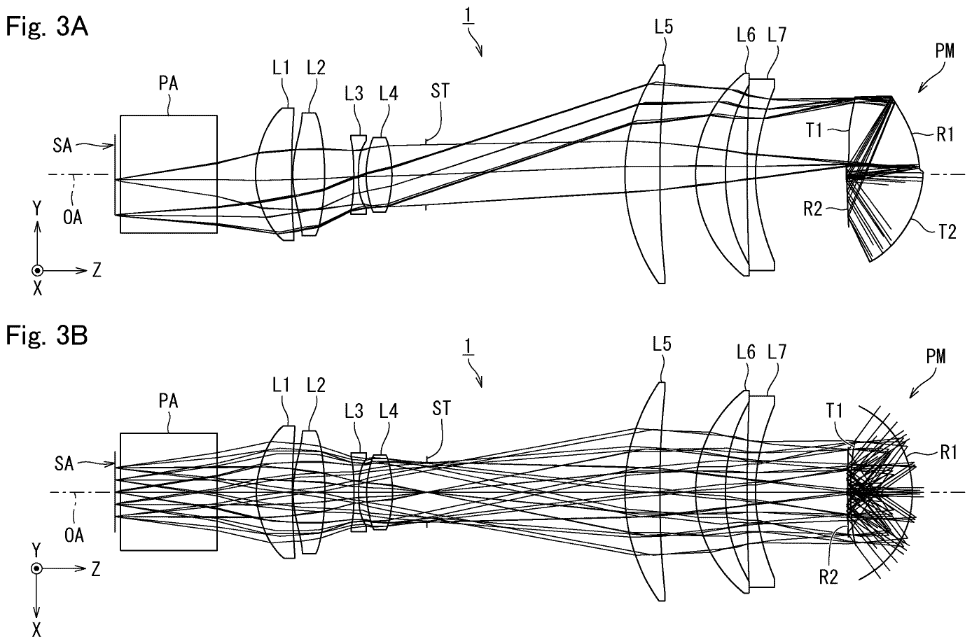

FIGS. 3A and 3B are layout diagrams illustrating the optical system 1 according to Example 3. FIG. 3A is a side view illustrating a YZ plane, and FIG. 3B is a top view illustrating an XZ plane. The optical system 1 has the same configuration as that of Example 1, and the description overlapping with that of Example 1 will be omitted. The optical system 1 includes a first sub-optical system including a plurality of lens elements and an aperture stop ST, and a second sub-optical system including a prism PM. In FIG. 3A, a reduction conjugate point which is an imaging position on the reduction side is located on the left side of the optical axis OA, and a magnification conjugate point which is an imaging position on the magnification side is located on the upper left side of the optical axis OA. The second sub-optical system is provided on the magnification side with respect to the first sub-optical system on the optical path.

Intermediate imaging positions that are conjugate with the reduction conjugate point and the magnification conjugate point, respectively, are located inside the optical system 1. As the intermediate imaging positions, both the Y-direction intermediate image IMy and the X-direction intermediate image IMx are present inside the prism PM as in FIG. 1. A part of the intermediate imaging positions is present inside the prism PM.

The first sub-optical system includes an optical element PA and lens elements L1 to L7 in order from the reduction side to the magnification side. A reduction conjugate point is set at a position at a predetermined distance from the end surface on the reduction side of the optical element PA, and the original image SA is installed therein.

The optical element PA includes two transmission surfaces that are parallel and flat (S1, S2). For surface numbers, reference is made to later-described numerical examples. The lens element L1 has a positive meniscus shape with a convex surface facing the reduction side (S3, S4). The lens element L2 has a biconvex shape (S5, S6). The lens element L3 has a biconcave shape (S7, S8). The lens element L4 has a biconvex shape (S9, S10). The lens element L5 has a positive meniscus shape with a convex surface facing the reduction side (S13, S14). The lens element L6 has a positive meniscus shape with a convex surface facing the reduction side (S15, S16). The lens element L7 has a biconcave shape having a negative meniscus shape with a convex surface facing the reduction side (S17, S18). These lens elements L1 to L7 are rotationally symmetric lenses having a surface shape rotationally symmetric about the optical axis OA of the first sub-optical system, and portions through which light ray does not pass may be deleted as necessary.

The aperture stop ST defines a range in which the light flux passes through the optical system 1, and is positioned between the reduction conjugate point and the above-described intermediate imaging positions. As an example, the aperture stop ST is located between the lens element L4 and the lens element L5 (S11).

The prism PM includes, as a plurality of optical surfaces, a first transmission surface T1 located closest to the first sub-optical system on the optical path between the first sub-optical system and the magnification conjugate point, a second transmission surface T2 located closest to the magnification conjugate point on the optical path between the first sub-optical system and the magnification conjugate point, and a first reflective surface R1 located closest to the first transmission surface T1 and a second reflective surface R2 located closest to the second transmission surface T2 on the optical path between the first transmission surface T1 and the second transmission surface T2. The first reflective surface R1 and the second reflective surface R2 constitute a reflective surface group. The first transmission surface T1 has a free-form surface shape with a convex surface facing the magnification side (S19). The first reflective surface R1 has a free-form surface shape with a concave surface facing the direction in which the light ray incident on the first reflective surface R1 is reflected (S20). The second reflective surface R2 has a free-form surface shape with a convex surface facing the direction in which the light ray incident on the second reflective surface R2 is reflected (S21). The second transmission surface T2 has a free-form surface shape with a convex surface facing the magnification side (S22).

A dielectric multilayer film including no metal layer is formed on both the first reflective surface R1 and the second reflective surface R2 of the prism PM or only the second reflective surface R2. A specific example of the dielectric multilayer film will be described later.

Next, the conditions that can be satisfied by the optical system according to the present embodiment will be described. Although a plurality of conditions are defined for the optical system according to each example, all of the plurality of conditions may be satisfied, or by satisfying individual conditions, corresponding effects can be obtained.

The present embodiment is a projection optical system having a reduction conjugate point on a reduction side and a magnification conjugate point on a magnification side, and having intermediate imaging position being conjugate with the reduction conjugate point and the magnification conjugate point inside, the projection optical system including:
a first sub-optical system; and
a second sub-optical system disposed closer to the magnification side than the first sub-optical system,
in which
the first sub-optical system includes a plurality of lenses L1 to L11,
the second sub-optical system includes a prism PM formed of a transparent medium,
the prism PM includes a first transmission surface T1 located closest to the first sub-optical system on an optical path between the first sub-optical system and the magnification conjugate point; a second transmission surface T2 located closest to the magnification conjugate point; and a reflective surface group including a second reflective surface R2 located closest to the second transmission surface T2 on the optical path between the first transmission surface T1 and the second transmission surface T2,
all or a part of each of the intermediate imaging position is present inside the prism, and
the second reflective surface R2 is formed with a dielectric multilayer film including no metal layer.

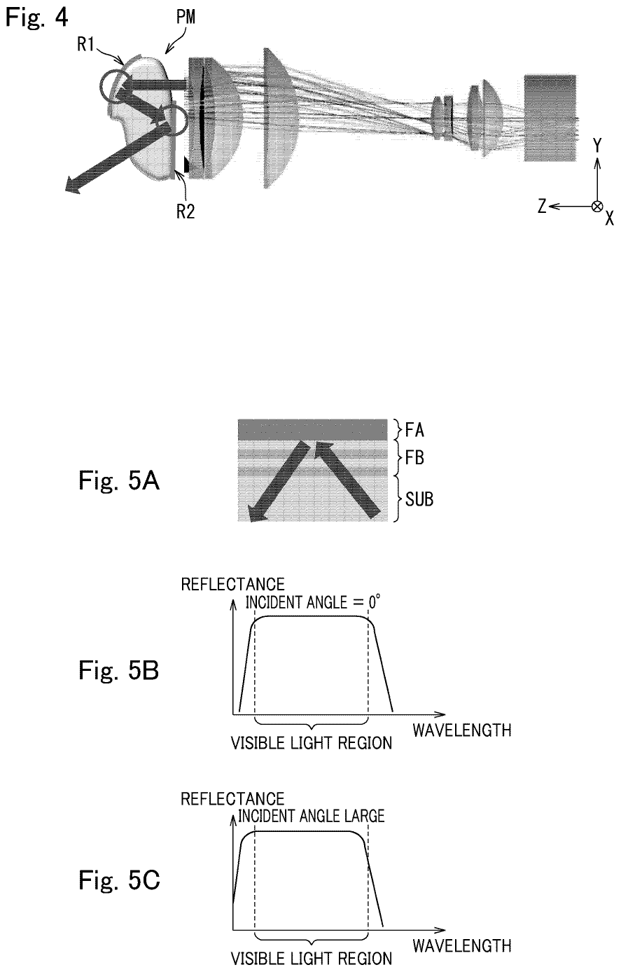

FIG. 4 is an explanatory diagram illustrating reflection of light inside the prism PM having two reflective surfaces R1 and R2. In the present specification, the prism PM having a reflective surface group including two reflective surfaces R1 and R2 is exemplified, but the same applies to a prism having a reflective surface group including one, or three or more reflective surfaces.

FIG. 5A illustrates a reflective coating structure in which an enhanced reflective coating FB and a metal reflective film FA are formed on a surface of a substrate (prism material) SUB as a comparative example. The enhanced reflective coating FB is generally formed of a dielectric multilayer film, and the metal reflective film FA is formed of, for example, Al, Au, Ag, Ni, Cr, or the like.

FIGS. 5B and 5C are graphs illustrating reflectance spectrum characteristics of the reflective coating of FIG. 5A. The vertical axis represents reflectance, and the horizontal axis represents the wavelength of light. As illustrated in FIG. 5B, when the incident angle θ=0° (incident perpendicularly to the reflective surface), the reflectance shows a substantially constant value in the visible light region. On the other hand, as illustrated in FIG. 5C, when the incident angle θ increases (for example, θ=15° to 30°) (obliquely incident on the reflective surface), the reflectance spectrum shifts to the short wavelength side as a whole, and in particular, reflection of red light decreases. As a result, the white image projected on the screen becomes bluish at the periphery of the image while being white near the center.

In particular, a free-form surface prism has a large change width of the incident angle with respect to the prism reflective surface to realize ultra short throw projection or hypershift, and a light ray exceeding the critical angle is also incident. In particular, the metal reflective film FA does not totally reflect a light ray even though the incident angle exceeds the critical angle. Thus, in the structure of the metal reflective film FA and the enhanced reflective coating FB as illustrated in FIG. 5A, color unevenness occurs in the peripheral portion of the image.

Further, because the metal reflective film FA generates heat through light absorption, the shape and curvature of the reflective surface vary because of thermal expansion of the prism. In particular, pin blurring, comatic aberration, and field curvature because of average picture level (APL) drift occur in projection with high luminance for a long time.

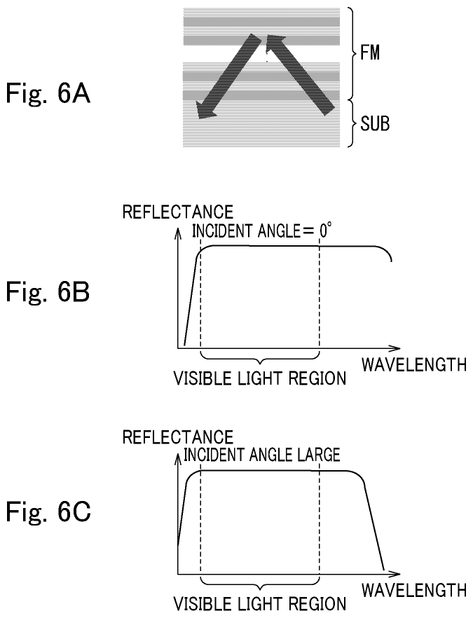

FIG. 6A illustrates a reflective coating structure in which the dielectric multilayer film FM including no metal layer is formed on the surface of the substrate SUB. The dielectric multilayer film FM is generally formed of a dielectric multilayer film in which a high refractive index material and a low refractive index material are alternately stacked.

FIGS. 6B and 6C are graphs illustrating reflectance spectrum characteristics of the reflective coating of FIG. 6A. The vertical axis represents reflectance, and the horizontal axis represents the wavelength of light. As illustrated in FIG. 6B, when the incident angle θ=0°, the reflectance shows a substantially constant value in the visible light region, and a flat range extends as compared with the reflective coating of FIG. 6B. As illustrated in FIG. 6C, when the incident angle θ increases (for example, θ=15° to 30°), the reflectance spectrum shifts to the short wavelength side as a whole, but the reflectance of the red light does not change much.

By adopting the dielectric multilayer film including no metal layer as described above, the reflection characteristics up to total reflection can be improved, and the reflection characteristics of light having a large angle change can also be favorably maintained. In addition, because light absorption by the metal reflective film does not occur, heat generation on the reflective surface can be suppressed, and APL drift can be reduced.

In the projection optical system according to the present embodiment, an average reflectance of S-polarized light and P-polarized light of the dielectric multilayer film may be larger than 95% with respect to incident light having a wavelength in a range of 440 nm or more and 480 nm or less at an incident angle between an angle smaller than a critical angle by 5 degrees or less and the critical angle.

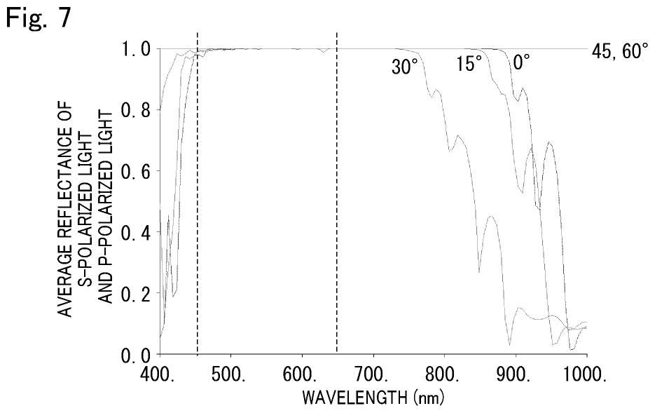

FIG. 7 is a graph illustrating an example of reflectance spectrum characteristics of a typical dielectric multilayer film. The vertical axis represents the average reflectance of S-polarized light and P-polarized light, and the horizontal axis represents the wavelength of light. In the case of the incident angle θ=0°, the reflectance is flat at about 1.0 in the wavelength range of about 450 nm to about 890 nm, but the reflectance decreases with a ripple including a plurality of peaks and valleys when the wavelength is longer than about 890 nm, and the reflectance becomes about 0.1 or less around the wavelength of 970 nm. As the incident angle θ increases, the entire reflectance spectrum tends to shift to the short wavelength side, and in the case of the incident angle θ=15°, when the wavelength becomes longer than around 860 nm, the reflectance decreases with a ripple. In the case of the incident angle θ=30°, when the wavelength becomes longer than the wavelength around 740 nm, the reflectance decreases with a ripple. In the case of the incident angles θ=45° and 60°, because the incident angles are larger than the critical angle of the dielectric multilayer film, the reflectance is about 1.0 and flat up to a wavelength of 1000 nm.

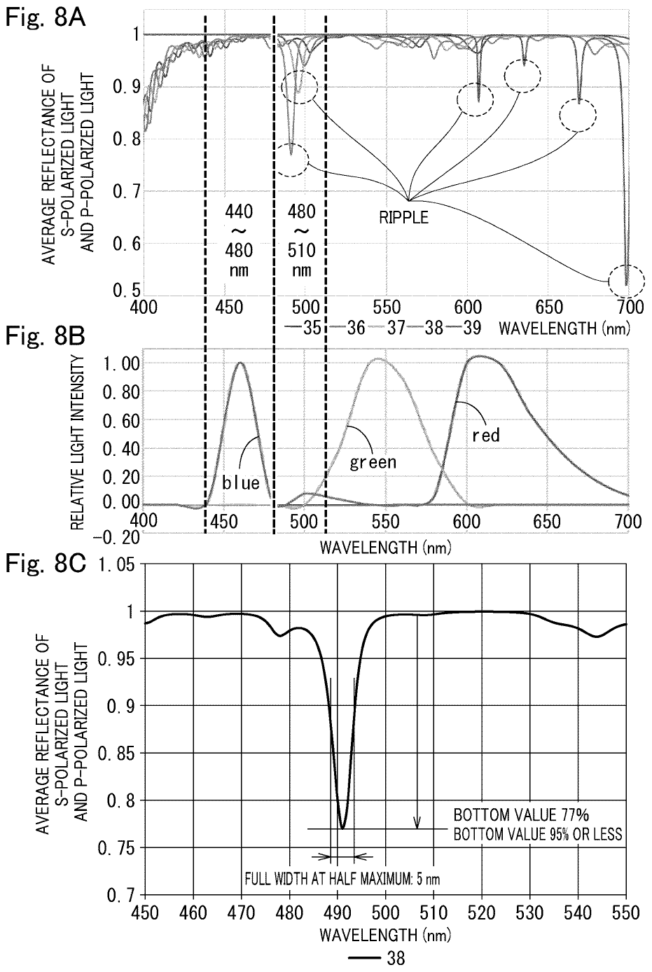

FIG. 8A is a graph illustrating an example of reflectance spectrum characteristics of another typical dielectric multilayer film, in which the vertical axis represents the average reflectance of S-polarized light and P-polarized light, and the horizontal axis represents the wavelength of light. FIG. 8B is a graph illustrating an example of emission spectrum characteristics of a light source used in a projection apparatus, in which the vertical axis represents the relative light intensity, and the horizontal axis represents the wavelength of light. When a high-luminance color LED is adopted as the light source, blue light (blue) exhibits a Gaussian emission spectrum of 440 to 480 nm having a peak wavelength of about 460 nm. Green light (green) shows a Gaussian emission spectrum of 500 to 600 nm having a peak wavelength of about 545 nm. Red light (red) shows a Gaussian emission spectrum of 575 to 700 nm having a peak wavelength of about 610 nm. Blue light tends to have a narrower emission spectral width than green light and red light, and it can be seen that the light intensity of the light source is small particularly in the range of 480 to 510 nm.

On the other hand, as in the upper graph, the dielectric multilayer film exhibits reflectance spectrum characteristics having a plurality of ripples, and the position of the ripple valley changes according to the incident angle θ=35°, 36°, 37°, 38°, and 39° of the critical angle (=40°) or less.

Thus, the average reflectance of the S-polarized light and the P-polarized light of the dielectric multilayer film is larger than 95% with respect to the incident light having a wavelength in the range of 440 nm or more and 480 nm or less between the incident angle of an angle smaller than the critical angle by 5 degrees or less and the critical angle, and the reflectance spectrum characteristics with respect to the blue light become substantially constant. Thus, color unevenness of the blue light can be suppressed. The reflectance of the dielectric multilayer film can be calculated using the Fresnel formula, and the reflectance is different between P-polarized light having an electric field parallel to the incident surface and S-polarized light having an electric field perpendicular to the incident surface. Thus, the average of the reflectance of the P-polarized light and the reflectance of the S-polarized light is adopted.

In the projection optical system according to the present embodiment, the average reflectance of S-polarized light and P-polarized light of the dielectric multilayer film may have a ripple in which the average reflectance of S-polarized light and P-polarized light is 95% or less with respect to incident light having a wavelength in a range of more than 480 nm and 510 nm or less at an incident angle between an angle smaller than a critical angle by 5 degrees or less and the critical angle.

As illustrated in FIG. 8A, the ripple valley appearing in the reflectance spectrum of the dielectric multilayer film is present in the range of 480 to 510 nm where the light intensity of the light source is small, and thus, color unevenness of blue light and green light can be suppressed. The ripple valley can be defined as a region where the reflectance is 95% or less as illustrated in FIG. 8C.

In the projection optical system according to the present embodiment,
the reflective surface group may include a first reflective surface R1 and the second reflective surface R2 in order from a reduction side on the optical path,
an absolute value of an optical power of the first reflective surface R1 may be larger than an absolute value of an optical power of the second reflective surface R2, and
the dielectric multilayer film may be formed on both of the first reflective surface R1 and the second reflective surface R2 or only on the second reflective surface R2.

According to such a configuration, light from the light source is condensed more on the second reflective surface than on the first reflective surface R1, and heat generation due to light absorption also increases. Thus, the dielectric multilayer film may be formed on both the first reflective surface R1 and the second reflective surface R2, or may be formed only on the second reflective surface R2 from the viewpoint of cost. This makes it possible to suppress thermal expansion of the second reflective surface.

In the projection optical system according to the present embodiment, the intermediate imaging positions may be located between the first transmission surface T1 and the reflective surface group.

According to such a configuration, the size of the prism PM can be reduced, and the first reflective surface R1 can be hardly affected by heat.

In the projection optical system according to the present embodiment, B≥3×A may be satisfied where A is a major diameter of a footprint of a first principal light ray on the second reflective surface R2, the first principal light ray being closest to the optical axis OA, and B is a major diameter of a footprint of a second principal light ray on the second reflective surface R2, the second principal light ray being farthest from the optical axis OA.

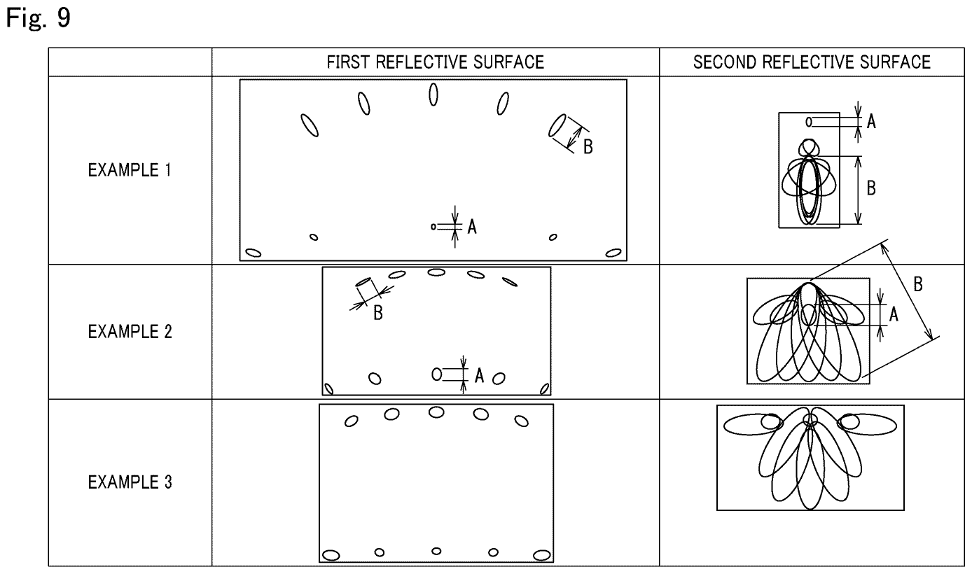

FIG. 9 is an explanatory view illustrating shapes of footprints on the first reflective surface R1 and the second reflective surface R2 according to Examples 1 to 3. In Examples 1 to 3, the first principal light ray passes through a position close to the lower end of the first reflective surface R1, and then passes through a position close to the upper end of the second reflective surface R2. The second principal light ray passes through a position close to the upper end of the first reflective surface R1, and then passes through a position close to the center of the second reflective surface R2. The footprint of the first principal light ray tends to be larger than the footprint of the second principal light ray, and this tendency is particularly large in the second reflective surface R2. When the shape of the footprint is large in the image peripheral portion involving the second principal light ray, when heat generation due to light absorption increases in the second reflective surface R2, image quality deterioration such as comatic aberration and drift easily occurs only in the image peripheral portion. As a countermeasure, image quality deterioration due to heat generation can be suppressed by providing the dielectric multilayer film on the second reflective surface R2.

In the projection optical system of the present embodiment, the second reflective surface R2 may reflect both the first light ray having the incident angle at which the total reflection is performed and the second light ray having the incident angle at which the total reflection is not performed.

According to such a configuration, the first light totally reflected by the second reflective surface R2 has a reflectance of 100%, which is the most efficient. In addition, because it is sufficient to optimize the range of the incident angle from 0° to the total reflection angle in the design of the dielectric multilayer film, the reflectance characteristics up to the total reflection can be improved.

In the projection optical system according to the present embodiment, a light ray having an incident angle of 25° or more and 60° or less with respect to a normal line of an incident surface of each light ray traveling on the second reflective surface R2 may be incident on the second reflective surface R2.

According to such a configuration, by widening the incident angle on the second reflective surface R2, it is easy to obtain an ultra wide angle. On the other hand, when a metal reflective layer is used, it is difficult to correct a wide angle. Thus, a reflective film is formed of a dielectric multilayer film, film design is performed in a range of an incident angle smaller than the critical angle, reflectance in a use wavelength region is secured, and light rays having an incident angle larger than the critical angle are totally reflected. Thus, reflectance can be increased in a wavelength region and an incident angle region to be used, and color unevenness can be suppressed. In addition, even when ripples occur in the reflectance spectrum characteristics of the dielectric multilayer film, the ripples are less likely to decrease at a pinpoint. This is because the ripples occur at a certain angle, and the characteristics are averaged and the influence is reduced by making light rays incident at a wide angle.

In the projection optical system according to the present embodiment, an air layer may be present on a back surface of an effective area of the second reflective surface R2, and the prism may be in contact with an external member in a region other than the back surface of the effective area of the second reflective surface R2.

According to such a configuration, most of the light on the second reflective surface R2 is reflected by the dielectric multilayer film, but a part of the light passes through the dielectric multilayer film and is applied to the external member. Thus, heat is generated through light absorption. The presence of the air layer in the effective area of the second reflective surface R2 can prevent the heat from reaching the effective area, and drift can be suppressed.

In the projection optical system according to the present embodiment, an air layer having a thickness of 5 mm or more may be present on a back surface of an effective area of the second reflective surface R2.

According to such a configuration, it is possible to reliably prevent the heat generated in the external member from reaching the effective area, and drift can be suppressed.

In the projection optical system according to the present embodiment, the dielectric multilayer film may include 54 or more layers having different refractive indexes, the layers being alternately stacked.

According to such a configuration, high reflectance can be secured in the wavelength range of 450 to 680 nm over a wide incident angle range, and color unevenness can be suppressed.

In the projection optical system according to the present embodiment, the dielectric multilayer film may have an extinction coefficient of 0.1 or less at normal temperature (20° C. to 30° C.) with respect to incident light having a wavelength of 632.8 nm.

According to such a configuration, heat generation due to light absorption of the dielectric multilayer film is reduced, and drift can be suppressed. For example, Nb₂O₅ has a refractive index of 2.316 and an attenuation coefficient of 0.000 at a wavelength of 632.8 nm. SiO₂ has a refractive index of 1.965 and an attenuation coefficient of 0.011 at a wavelength of 632.8 nm.

In the projection optical system according to the present embodiment, the dielectric multilayer film may be constituted by alternately stacking a high refractive index layer having a refractive index of 2.0 or more and a low refractive index layer having a refractive index of 1.6 or less.

According to such a configuration, the reflectance of the dielectric multilayer film can be increased. As the high refractive index layer having a refractive index of 2.0 or more, for example, CeO₂ (cerium oxide, refractive index n=2.2 at wavelength 550 nm), Nb₂O₅ (niobium pentoxide, n=2.33 at 500 nm), SnO₂ (tin oxide, n=2 at 550 nm), Ta₂O₅ (tantalum pentoxide, n=2.16 at 550 nm), Ti₃O₅ (titanium pentoxide, n=2.3 to 2.55 at 550 nm), TiO (titanium monoxide, n=2.3 to 2.55 at 550 nm), TiO₂ (titanium dioxide, n=2.3 to 2.55 at 550 nm), WO₃ (tungsten oxide, n=2.2 at 550 nm), ZnO (zinc oxide, n=2.1 at 550 nm), ZrO₂ (zirconium oxide, n=2.05 at 550 nm), ZRT2 (ZrO₂+TiO₂, n=2.1 at 550 nm), ZnS (zinc sulfide, n=2.35 at 550 nm), and the like can be used.

As the low refractive index layer having a refractive index of 1.6 or less, for example, SiO₂ (silicon oxide, n=1.46 at 500 nm), AlF₃ (aluminum fluoride, n=1.38 at 550 nm), BaF₂ (barium fluoride, n=1.48 at 550 nm), CaF₂ (calcium fluoride, n=1.23 to 1.45 at 550 nm), LiF (lithium fluoride, n=1.3 at 550 nm), MgF₂ (magnesium fluoride, n=1.38 to 1.4 at 550 nm), NaF (sodium fluoride, n=1.34 at 550 nm), and the like can be used.

In the projection optical system according to the present embodiment, the second reflective surface R2 may have a reflectance of 95% or more across 450 to 850 nm at normal incidence with the dielectric multilayer film.

According to such a configuration, high reflectance can be secured over a wavelength of 450 to 850 nm, and thus, color unevenness can be suppressed.

In the projection optical system according to the present embodiment, the prism PM may be made of glass.

According to such a configuration, because the linear expansion coefficient of glass is small, the shape change becomes small with respect to the temperature change, and the drift can be suppressed.

The projection optical system according to the present embodiment may project light of 3000 lumens or more.

According to such a configuration, a bright projection image can be obtained even in a projection range of 150 inches or more.

In the projection optical system according to the present embodiment, a protective layer may be formed on the second reflective surface R2 on a side opposite to the prism PM of the dielectric multilayer film.

According to such a configuration, aging of the dielectric multilayer film can be prevented because of the presence of the protective layer. Such a protective layer can be formed of silicon dioxide (SiO₂), magnesium fluoride (MgF₂), or the like.

The present embodiment is also a projection optical system having a reduction conjugate point on a reduction side and a magnification conjugate point on a magnification side, and having intermediate imaging position being conjugate with the reduction conjugate point and the magnification conjugate point inside, the projection optical system including:
a first sub-optical system; and
a second sub-optical system disposed closer to the magnification side than the first sub-optical system,
in which
the first sub-optical system includes a plurality of lenses L1 to L11,
the second sub-optical system includes a prism PM formed of a transparent medium,
the prism PM includes: a first transmission surface T1 located closest to the first sub-optical system on an optical path between the first sub-optical system and the magnification conjugate point; a second transmission surface T2 located closest to the magnification conjugate point; and a reflective surface group including a second reflective surface R2 located closest to the second transmission surface T2 on the optical path between the first transmission surface T1 and the second transmission surface,
all or a part of each of the intermediate imaging positions is present inside the prism, and
the second reflective surface R2 is formed with a coating layer (for example, dielectric multilayer film) that reflects both a first light ray having an incident angle at which total reflection is performed and a second light ray having an incident angle at which total reflection is not formed.

According to such a configuration, the first light totally reflected by the second reflective surface R2 has a reflectance of 100%, which is the most efficient. In addition, because it is sufficient to optimize the range of the incident angle from 0° to the total reflection angle in the design of the dielectric multilayer film, the reflectance characteristics up to the total reflection can be improved.

In the projection optical system according to the present embodiment, the coating layer may be formed on all the reflective surfaces of the reflective surface group.

According to such a configuration, the reflectance characteristics of the reflective surface group can be improved.

Hereinafter, numerical examples of the optical systems according to Examples 1 to 3 will be described. In each numerical example, the unit of the length in the tables is all “mm”, and the unit of the angle of view is all “0”. In each numerical example, the surface type (XY polynomial surface, spherical surface, aspherical surface), curvature radius, surface interval, d-line refractive index, d-line Abbe number, material, refraction/reflection, eccentricity type, Y eccentricity amount, and Z eccentricity a rotation amount are illustrated. Various amounts of the numerical examples are calculated based on a wavelength of 550 nm. In each numerical example, the shape of an aspheric surface is defined by the following formula. As the aspheric coefficient, only a coefficient that is not 0 except the conic constant k is described.

$$z = \frac{c {r}^{2}}{1 + \sqrt{1 - ( 1 + k ) {c}^{2} {r}^{2}}} + {Ar}^{4} + {Br}^{6} + {Cr}^{8} + {Dr}^{10} + {Er}^{12} + {Fr}^{14} + {Hr}^{16} + {Hr}^{18} \qquad [ Mathematical Formula 1 ]$$

Here,
z: a sag height of a surface parallel to a z axis;
r: a distance in a radial direction (=a square root of (x²+y²));
c: a curvature at a surface vertex;
k: a conic constant; and
A to H: 4th to 18th order coefficients of r.

The free-form surface shape is defined by the following formulas using a local orthogonal coordinate system (x, y, z) with the surface vertex as an origin.

$$Z = \frac{c {r}^{2}}{1 + \sqrt{1 - ( 1 + k ) {c}^{2} {r}^{2}}} + {\sum }_{j = 2}^{137} {C}_{j} {x}^{m} {y}^{n} \qquad [ Mathematical Formula 2 ]$$

$$j = \frac{{( m + n )}^{2} + m + 3 n}{2} + 1 \qquad [ Mathematical Formula 3 ]$$

Here,
z: a sag height of a surface parallel to a z axis;
r: a distance in a radial direction (=a square root of (x²+y²));
c: a curvature at a surface vertex;
k: a conic constant; and
Cⱼ: a coefficient of monomial x^{m}yⁿ.

In each of the following data, an i-th order term of x and a j-th order term of y, which are free-form surface coefficients in the polynomial, are described as x**i*y**j. For example, “X**2*Y” indicates a free-form surface coefficient of a quadratic term of x and a linear term of y in the polynomial.

### Numerical Example 1

For the optical system of Numerical Example 1 (corresponding to Example 1), the lens data is shown in Table 1, the aspherical shape data of the lens and the data of the object height and the image height in the optical path are shown in Table 2, and the free-form surface shape data of the prism is shown in Table 3. Specific configurations of the dielectric multilayer films formed on the first reflective surface R1 and/or the second reflective surface R2 of the prism are shown in Tables 4 to 6. “Decenter and Return (DAR)” in Table 1 means coordinate transformation between global coordinates and local coordinates at the time of numerical calculation. In Table 2, “f1 to f10” means the evaluated image height. The same applies to other numerical examples.

TABLE 1

| Reduction | Surface | | Radius of | Surface | | Refractive/ |
|---|---|---|---|---|---|---|
| side | number | Surface type | curvature | interval | Material | Reflective |
| SA | Object | | | 0.000 | | Refractive |
| PA | S1 | | ∞ | 11.600 | BK7_SCHOTT | Refractive |
| PA | S2 | | ∞ | 10.668 | | Refractive |
| L1 | S3 | | 16.605 | 6.308 | EFD80_HOYA | Refractive |
| L1 | S4 | | −132.601 | 1.372 | | Refractive |
| L2 | S5 | Aspherical | 46.272 | 1.801 | LTIM28_OHARA | Refractive |
| L2 | S6 | Aspherical | 20.650 | 1.220 | | Refractive |
| L3 | S7 | | 13.790 | 6.069 | FCD1_HOYA | Refractive |
| L3 | S8 | | −27.154 | 0.200 | | Refractive |
| L4 | S9 | | 68.929 | 1.000 | TAFD5G_HOYA | Refractive |
| L5 | S10 | | 8.108 | 8.231 | FCD100_HOYA | Refractive |
| L5 | S11 | | −13.795 | 0.200 | | Refractive |
| L6 | S12 | Aspherical | 163.300 | 1.762 | MCFDS91050_HOYA | Refractive |
| L6 | S13 | Aspherical | 20.184 | 1.844 | | Refractive |
| ST | S14 | Aperture | ∞ | 16.926 | | Refractive |
| | | stop | | | | |
| L7 | S15 | | 79.219 | 9.761 | FD225_HOYA | Refractive |
| L7 | S16 | | −36.558 | 3.183 | | Refractive |
| L8 | S17 | | 24.229 | 6.467 | FCD500_HOYA | Refractive |
| L8 | S18 | | 367.909 | 2.452 | | Refractive |
| L9 | S19 | | −45.478 | 1.801 | EFDS1W_HOYA | Refractive |
| L9 | S20 | | −98.156 | 3.144 | | Refractive |
| L10 | S21 | | −31.050 | 1.818 | FDS90SG_HOYA | Refractive |
| L10 | S22 | | 64.036 | 3.709 | | Refractive |
| L11 | S23 | Aspherical | −38.689 | 7.864 | Z330R_ZEON | Refractive |
| L11 | S24 | Aspherical | −190.792 | 10.040 | | Refractive |
| T1 | S25 | XY | −46.980 | 28.000 | KVC80_SUMITA | Refractive |
| | | polynomial | | | | |
| R1 | S26 | XY | −13.410 | −10.000 | KVC80_SUMITA | Reflective |
| | | polynomial | | | | |
| R2 | S27 | XY | 4234.836 | −28.067 | KVC80_SUMITA | Reflective |
| | | polynomial | | | | |
| T2 | S28 | XY | 24.598 | −359.345 | | Refractive |
| | | polynomial | | | | |
| SR | | | ∞ | 0.000 | | |
| Magnification | | | | | | |
| side | | | | | | |

Eccentricity type DAR

| | Y | Z |
|---|---|---|
| | eccentricity | eccentricity |
| S23 | −0.0377 | 0.0000 |
| S24 | −0.0377 | 0.0000 |
| S25 | 0.5266 | 0.0000 |
| S26 | 1.3482 | 0.0000 |
| S27 | −0.1226 | −5.0222 |
| S28 | −0.0125 | 0.0000 |

| | Aperture diameter |
|---|---|
| Aperture stop | 5.794 |

TABLE 2

| Aspheric coefficient | | | | | | |
|---|---|---|---|---|---|---|
| Surface number | S5 | S6 | S12 | S13 | S23 | S24 |
| Y radius of curvature | 46.272 | 20.650 | 163.300 | 20.184 | −38.689 | −190.792 |
| Conic constant | −3.371 | 0.081 | 1.208 | −2.665 | 0.000 | 0.000 |
| 4th order coefficient | −7.866E−05 | 7.715E−05 | 1.655E−04 | 1.660E−04 | 7.904E−05 | −7.772E−05 |
| 6th order coefficient | −2.492E−07 | 2.901E−07 | 4.703E−07 | 6.301E−07 | −1.294E−07 | 4.012E−08 |
| 8th order coefficient | −2.620E−10 | 3.409E−09 | 1.331E−08 | −2.989E−08 | 1.828E−10 | 3.215E−10 |
| 10th order coefficient | 9.195E−12 | −2.060E−11 | 0.000E+00 | 0.000E+00 | −2.478E−13 | −6.185E−13 |

| | |
|---|---|
| Object height | Image height |

| | X | Y | X | Y |
|---|---|---|---|---|
| f1 | 0.000 | −1.371 | 0.0 | 291.3 |
| f2 | 0.000 | −7.348 | 0.0 | 1565.2 |
| f3 | 2.592 | −1.371 | 551.2 | 292.4 |
| f4 | 2.592 | −7.348 | 553.5 | 1563.1 |
| f5 | 5.184 | −1.371 | 1105.1 | 293.0 |
| f6 | 5.184 | −7.348 | 1106.9 | 1566.1 |
| f7 | −2.592 | −1.371 | −551.2 | 292.4 |
| f8 | −2.592 | −7.348 | −553.5 | 1563.1 |
| f9 | −5.184 | −1.371 | −1105.1 | 293.0 |
| f10 | −5.184 | −7.348 | −1106.9 | 1566.1 |

TABLE 3
XY polynomial surface coefficient

| | Conic constant | 0.477 | | | | | | | | | |
|---|---|---|---|---|---|---|---|---|---|---|---|
| S25 | X**0 | X**1 | X**2 | X**3 | X**4 | X**5 | X**6 | X**7 | X**8 | X**9 | X**10 |
| Y**0 | | 0.00000E+00 | −9.51826E−03 | 0.00000E+00 | 7.02060E−05 | 0.00000E+00 | −3.73923E−07 | 0.00000E+00 | 1.52749E−09 | 0.00000E+00 | −2.22373E−12 |
| Y**1 | −1.90610E−02 | 0.00000E+00 | 1.81132E−04 | 0.00000E+00 | 4.41671E−07 | 0.00000E+00 | 1.98290E−08 | 0.00000E+00 | −1.19614E−10 | 0.00000E+00 | |
| Y**2 | −4.40958E−03 | 0.00000E+00 | 8.86919E−05 | 0.00000E+00 | −1.16691E−06 | 0.00000E+00 | 4.33541E−09 | 0.00000E+00 | −2.17003E−12 | | |
| Y**3 | −2.80877E−04 | 0.00000E+00 | 5.93742E−06 | 0.00000E+00 | 2.08686E−08 | 0.00000E+00 | −1.55529E−10 | 0.00000E+00 | | | |
| Y**4 | 7.16862E−05 | 0.00000E+00 | −1.20589E−06 | 0.00000E+00 | 7.94258E−09 | 0.00000E+00 | −1.16200E−11 | | | | |
| Y**5 | 3.42979E−07 | 0.00000E+00 | −5.12083E−09 | 0.00000E+00 | −2.06869E−10 | 0.00000E+00 | | | | | |
| Y**6 | −3.50283E−07 | 0.00000E+00 | 5.70343E−09 | 0.00000E+00 | −1.26161E−11 | | | | | | |
| Y**7 | 2.96041E−09 | 0.00000E+00 | −4.57421E−11 | 0.00000E+00 | | | | | | | |
| Y**8 | 1.35123E−09 | 0.00000E+00 | −8.95519E−12 | | | | | | | | |
| Y**9 | −2.75126E−11 | 0.00000E+00 | | | | | | | | | |
| Y**10 | −1.28427E−12 | | | | | | | | | | |

| | Conic constant | −0.851 | | | | | | | | | |
|---|---|---|---|---|---|---|---|---|---|---|---|
| S26 | X**0 | X**1 | X**2 | X**3 | X**4 | X**5 | X**6 | X**7 | X**8 | X**9 | X**10 |
| Y**0 | | 0.000000E+00 | −7.141280E−04 | 0.000000E+00 | 3.678744E−05 | 0.000000E+00 | −5.490883E−08 | 0.000000E+00 | 1.351520E−10 | 0.000000E+00 | −1.380642E−13 |
| Y**1 | −1.198356E−01 | 0.000000E+00 | 2.662734E−04 | 0.000000E+00 | −2.851798E−07 | 0.000000E+00 | −2.428499E−09 | 0.000000E+00 | 5.483706E−12 | 0.000000E+00 | |
| Y**2 | 3.660194E−03 | 0.000000E+00 | 4.963505E−05 | 0.000000E+00 | −1.296753E−07 | 0.000000E+00 | 7.390179E−10 | 0.000000E+00 | −9.446921E−13 | | |
| Y**3 | −2.355332E−04 | 0.000000E+00 | 4.768588E−07 | 0.000000E+00 | 1.094080E−09 | 0.000000E+00 | −1.116077E−11 | 0.000000E+00 | | | |
| Y**4 | 5.166913E−05 | 0.000000E+00 | −1.310829E−07 | 0.000000E+00 | 5.973237E−10 | 0.000000E+00 | −2.959576E−13 | | | | |
| Y**5 | −3.192510E−07 | 0.000000E+00 | 7.337840E−10 | 0.000000E+00 | −1.933516E−11 | 0.000000E+00 | | | | | |
| Y**6 | −6.914238E−08 | 0.000000E+00 | 4.686804E−10 | 0.000000E+00 | 1.295535E−13 | | | | | | |
| Y**7 | 4.594971E−10 | 0.000000E+00 | −1.079683E−11 | 0.000000E+00 | | | | | | | |
| Y**8 | 1.565149E−10 | 0.000000E+00 | −7.059108E−14 | | | | | | | | |
| Y**9 | −6.349935E−13 | 0.000000E+00 | | | | | | | | | |
| Y**10 | −1.153973E−13 | | | | | | | | | | |

| | Conic constant | 0.629 | | | | | | | | | |
|---|---|---|---|---|---|---|---|---|---|---|---|
| S27 | X**0 | X**1 | X**2 | X**3 | X**4 | X**5 | X**6 | X**7 | X**8 | X**9 | X**10 |
| Y**0 | | 0.000000E+00 | −6.716070E−05 | 0.000000E+00 | −1.196274E−04 | 0.000000E+00 | 9.608682E−06 | 0.000000E+00 | 0.000000E+00 | 0.000000E+00 | 0.000000E+00 |
| Y**1 | 1.286189E−02 | 0.000000E+00 | −1.746471E−04 | 0.000000E+00 | 3.977355E−05 | 0.000000E+00 | 0.000000E+00 | 0.000000E+00 | 0.000000E+00 | 0.000000E+00 | |
| Y**2 | −2.110006E−04 | 0.000000E+00 | −2.199612E−06 | 0.000000E+00 | −4.820822E−06 | 0.000000E+00 | 0.000000E+00 | 0.000000E+00 | 0.000000E+00 | | |
| Y**3 | 2.345767E−05 | 0.000000E+00 | 1.083301E−05 | 0.000000E+00 | 0.000000E+00 | 0.000000E+00 | 0.000000E+00 | 0.000000E+00 | | | |
| Y**4 | 3.794465E−06 | 0.000000E+00 | 1.338595E−06 | 0.000000E+00 | 0.000000E+00 | 0.000000E+00 | 0.000000E+00 | | | | |
| Y**5 | −5.528213E−07 | 0.000000E+00 | −1.462411E−06 | 0.000000E+00 | 0.000000E+00 | 0.000000E+00 | | | | | |
| Y**6 | 2.101960E−07 | 0.000000E+00 | 2.235532E−07 | 0.000000E+00 | 0.000000E+00 | | | | | | |
| Y**7 | −6.198934E−08 | 0.000000E+00 | 0.000000E+00 | 0.000000E+00 | | | | | | | |
| Y**8 | 8.726146E−09 | 0.000000E+00 | 0.000000E+00 | | | | | | | | |
| Y**9 | −4.089429E−10 | 0.000000E+00 | | | | | | | | | |
| Y**10 | 4.341650E−12 | | | | | | | | | | |

| | Conic constant | 0.000 | | | | | | | | | |
|---|---|---|---|---|---|---|---|---|---|---|---|
| S28 | X**0 | X**1 | X**2 | X**3 | X**4 | X**5 | X**6 | X**7 | X**8 | X**9 | X**10 |
| Y**0 | | 0.000000E+00 | −4.964480E−03 | 0.000000E+00 | 4.690587E−05 | 0.000000E+00 | −1.506237E−07 | 0.000000E+00 | 2.106296E−10 | 0.000000E+00 | −1.116239E−13 |
| Y**1 | −8.291553E−02 | 0.000000E+00 | 2.944326E−04 | 0.000000E+00 | 1.017205E−07 | 0.000000E+00 | −5.329609E−10 | 0.000000E+00 | −7.166627E−14 | 0.000000E+00 | |
| Y**2 | 1.798938E−03 | 0.000000E+00 | 7.836622E−05 | 0.000000E+00 | −4.923557E−07 | 0.000000E+00 | 9.426840E−10 | 0.000000E+00 | −6.055981E−13 | | |
| Y**3 | 6.903173E−05 | 0.000000E+00 | 2.820743E−07 | 0.000000E+00 | −1.104421E−09 | 0.000000E+00 | 2.580767E−13 | 0.000000E+00 | | | |
| Y**4 | 3.598167E−05 | 0.000000E+00 | −4.828593E−07 | 0.000000E+00 | 1.486521E−09 | 0.000000E+00 | −1.302992E−12 | | | | |
| Y**5 | 4.898041E−08 | 0.000000E+00 | −1.037056E−09 | 0.000000E+00 | −6.120324E−13 | 0.000000E+00 | | | | | |
| Y**6 | −1.560350E−07 | 0.000000E+00 | 9.934437E−10 | 0.000000E+00 | −1.321688E−12 | | | | | | |
| Y**7 | −1.658231E−10 | 0.000000E+00 | −1.832740E−13 | 0.000000E+00 | | | | | | | |
| Y**8 | 2.475682E−10 | 0.000000E+00 | −6.729235E−13 | | | | | | | | |
| Y**9 | −9.317675E−14 | 0.000000E+00 | | | | | | | | | |
| Y**10 | −1.371854E−13 | | | | | | | | | | |

TABLE 4
Multilayer film example 1
Example 1 Reflective surface coating

| | | Refractive index | | | |
|---|---|---|---|---|---|
| | Film thickness | | Prism | Critical | |
| | [nm] | 1.694 | KVC80_SUMITA | angle | 36.2 |
| 1 | 77.2 | 2.358 | Dielectric | −1 | 35.2 |
| 2 | 89.0 | 1.461 | multilayer film | −2 | 34.2 |
| 3 | 87.1 | 2.358 | High refractive | −3 | 33.2 |
| 4 | 140.6 | 1.461 | index material + | −4 | 32.2 |
| 5 | 87.1 | 2.358 | Low refractive | −5 | 31.2 |
| 6 | 140.6 | 1.461 | index material | | |
| 7 | 87.1 | 2.358 | | | |
| 8 | 140.6 | 1.461 | | | |
| 9 | 87.1 | 2.358 | | | |
| 10 | 140.6 | 1.461 | | | |
| 11 | 87.1 | 2.358 | | | |
| 12 | 140.6 | 1.461 | | | |
| 13 | 87.1 | 2.358 | | | |
| 14 | 140.6 | 1.461 | | | |
| 15 | 81.0 | 2.358 | | | |
| 16 | 130.8 | 1.461 | | | |
| 17 | 81.0 | 2.358 | | | |
| 18 | 130.8 | 1.461 | | | |
| 19 | 81.0 | 2.358 | | | |
| 20 | 130.8 | 1.461 | | | |
| 21 | 81.0 | 2.358 | | | |
| 22 | 130.8 | 1.461 | | | |
| 23 | 81.0 | 2.358 | | | |
| 24 | 130.8 | 1.461 | | | |
| 25 | 81.0 | 2.358 | | | |
| 26 | 130.8 | 1.461 | | | |
| 27 | 70.6 | 2.358 | | | |
| 28 | 113.9 | 1.461 | | | |
| 29 | 70.6 | 2.358 | | | |
| 30 | 113.9 | 1.461 | | | |
| 31 | 70.6 | 2.358 | | | |
| 32 | 113.9 | 1.461 | | | |
| 33 | 70.6 | 2.358 | | | |
| 34 | 113.9 | 1.461 | | | |
| 35 | 70.6 | 2.358 | | | |
| 36 | 113.9 | 1.461 | | | |
| 37 | 70.6 | 2.358 | | | |
| 38 | 113.9 | 1.461 | | | |
| 39 | 62.8 | 2.358 | | | |
| 40 | 101.4 | 1.461 | | | |
| 41 | 62.8 | 2.358 | | | |
| 42 | 101.4 | 1.461 | | | |
| 43 | 62.8 | 2.358 | | | |
| 44 | 101.4 | 1.461 | | | |
| 45 | 62.8 | 2.358 | | | |
| 46 | 101.4 | 1.461 | Dielectric | | |
| 47 | 62.8 | 2.358 | multilayer film | | |
| 48 | 101.4 | 1.461 | High refractive | | |
| 49 | 62.8 | 2.358 | index material + | | |
| 50 | 101.4 | 1.461 | Low refractive | | |
| 51 | 52.4 | 2.358 | index material | | |
| 52 | 84.5 | 1.461 | | | |
| 53 | 52.4 | 2.358 | | | |
| 54 | 84.5 | 1.461 | | | |
| 55 | 52.4 | 2.358 | | | |
| 56 | 84.5 | 1.461 | | | |
| 57 | 52.4 | 2.358 | | | |
| 58 | 84.5 | 1.461 | | | |
| 59 | 52.4 | 2.358 | | | |
| 60 | 84.5 | 1.461 | | | |
| 61 | 52.4 | 2.358 | | | |
| 62 | 84.5 | 1.461 | | | |
| 63 | 66.2 | 2.358 | | | |
| 64 | 124.6 | 1.461 | | | |
| | | 1.000 | Air | | |

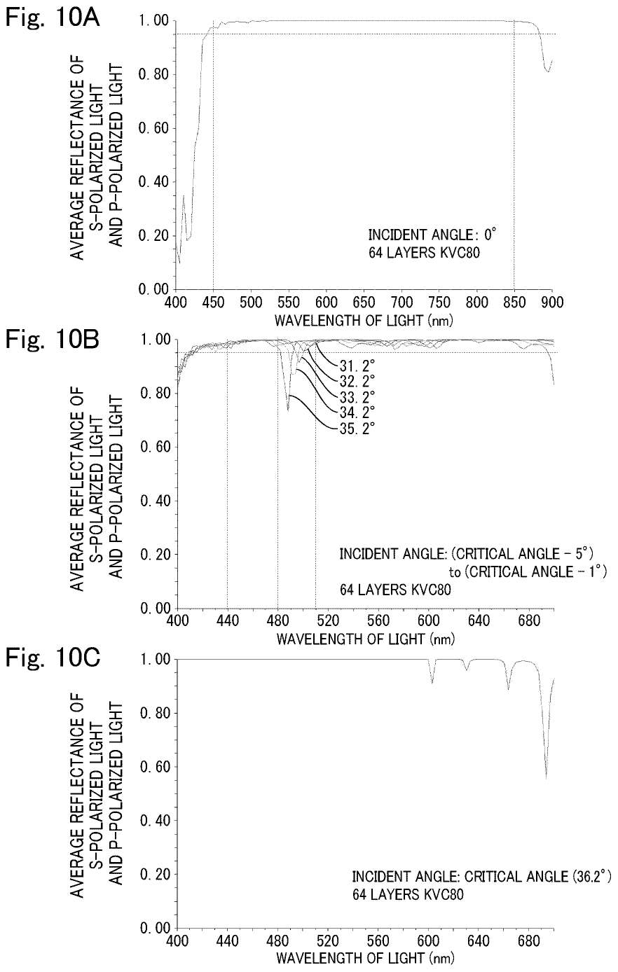

FIGS. 10A to 10C illustrate the reflectance spectrum characteristics of the dielectric multilayer film (Table 4, 64 layers) formed on glass KVC80. FIG. 10A illustrates the characteristics with an incident angle of 0° (normal incidence), FIG. 10B illustrates the characteristics with an incident angle of (critical angle −5°) to (critical angle −1°), and FIG. 10C illustrates the characteristics with an incident angle being the critical angle 36.2°.

TABLE 5
Multilayer film example 2
Example 1 Reflective surface coating

| | | Refractive index | | | |
|---|---|---|---|---|---|
| | Film thickness | | Prism | Critical | |
| | [nm] | 1.694 | KVC80_SUMITA | angle | 36.2 |
| 1 | 88.2 | 2.358 | Dielectric | −1 | 35.2 |
| 2 | 124.6 | 1.461 | multilayer film | −2 | 34.2 |
| 3 | 88.2 | 2.358 | High refractive | −3 | 33.2 |
| 4 | 142.3 | 1.461 | index material + | −4 | 32.2 |
| 5 | 88.2 | 2.358 | Low refractive | −5 | 31.2 |
| 6 | 142.3 | 1.461 | index material | | |
| 7 | 88.2 | 2.358 | | | |
| 8 | 142.3 | 1.461 | | | |
| 9 | 88.2 | 2.358 | | | |
| 10 | 142.3 | 1.461 | | | |
| 11 | 88.2 | 2.358 | | | |
| 12 | 142.3 | 1.461 | | | |
| 13 | 83.8 | 2.358 | | | |
| 14 | 135.2 | 1.461 | | | |
| 15 | 83.8 | 2.358 | | | |
| 16 | 135.2 | 1.461 | | | |
| 17 | 83.8 | 2.358 | | | |
| 18 | 135.2 | 1.461 | | | |
| 19 | 83.8 | 2.358 | | | |
| 20 | 135.2 | 1.461 | | | |
| 21 | 83.8 | 2.358 | | | |
| 22 | 135.2 | 1.461 | | | |
| 23 | 70.6 | 2.358 | | | |
| 24 | 113.9 | 1.461 | | | |
| 25 | 70.6 | 2.358 | | | |
| 26 | 113.9 | 1.461 | | | |
| 27 | 70.6 | 2.358 | | | |
| 28 | 113.9 | 1.461 | | | |
| 29 | 70.6 | 2.358 | | | |
| 30 | 113.9 | 1.461 | | | |
| 31 | 70.6 | 2.358 | | | |
| 32 | 113.9 | 1.461 | | | |
| 33 | 62.3 | 2.358 | | | |
| 34 | 100.5 | 1.461 | | | |
| 35 | 62.3 | 2.358 | | | |
| 36 | 100.5 | 1.461 | | | |
| 37 | 62.3 | 2.358 | | | |
| 38 | 100.5 | 1.461 | | | |
| 39 | 62.3 | 2.358 | | | |
| 40 | 100.5 | 1.461 | | | |
| 41 | 62.3 | 2.358 | | | |
| 42 | 100.5 | 1.461 | | | |
| 43 | 50.7 | 2.358 | | | |
| 44 | 81.8 | 1.461 | | | |
| 45 | 50.7 | 2.358 | | | |
| 46 | 81.8 | 1.461 | Dielectric | | |
| 47 | 50.7 | 2.358 | multilayer film | | |
| 48 | 81.8 | 1.461 | High refractive | | |
| 49 | 50.7 | 2.358 | index material + | | |
| 50 | 81.8 | 1.461 | Low refractive | | |
| 51 | 50.7 | 2.358 | index material | | |
| 52 | 81.8 | 1.461 | | | |
| 53 | 66.2 | 2.358 | | | |
| 54 | 124.6 | 1.461 | | | |
| | | 1.000 | Air | | |

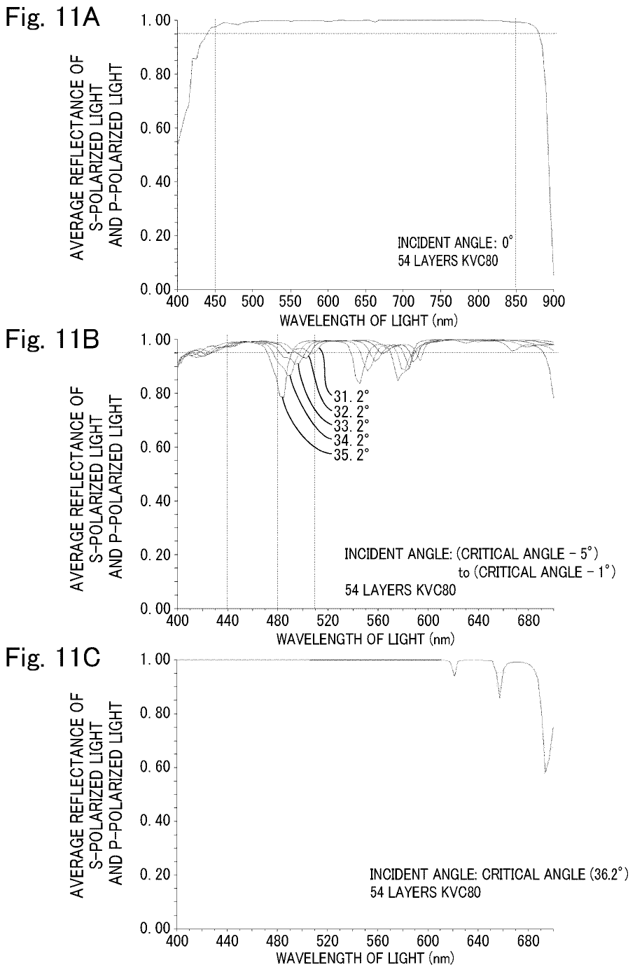

FIGS. 11A to 11C illustrate the reflectance spectrum characteristics of the dielectric multilayer film (Table 5, 54 layers) formed on glass KVC80. FIG. 11A illustrates the characteristics with an incident angle of 0° (normal incidence), FIG. 11B illustrates the characteristics with an incident angle of (critical angle −5°) to (critical angle −1°), and FIG. 11C illustrates the characteristics with an incident angle being the critical angle 36.2°.

TABLE 6
Multilayer film example 3
Example 1 Reflective surface coating

| | | Refractive index | | | |
|---|---|---|---|---|---|
| | Film thickness | | Prism | Critical | |
| | [nm] | 1.694 | KVC80_SUMITA | angle | 36.2 |
| 1 | 51.6 | 2.358 | Dielectric | −1 | 35.2 |
| 2 | 115.7 | 1.461 | multilayer film | −2 | 34.2 |
| 3 | 91.2 | 2.358 | High refractive | −3 | 33.2 |
| 4 | 147.2 | 1.461 | index material + | −4 | 32.2 |
| 5 | 91.2 | 2.358 | Low refractive | −5 | 31.2 |
| 6 | 147.2 | 1.461 | index material | | |
| 7 | 91.2 | 2.358 | | | |
| 8 | 147.2 | 1.461 | | | |
| 9 | 91.2 | 2.358 | | | |
| 10 | 147.2 | 1.461 | | | |
| 11 | 91.2 | 2.358 | | | |
| 12 | 147.2 | 1.461 | | | |
| 13 | 91.2 | 2.358 | | | |
| 14 | 147.2 | 1.461 | | | |
| 15 | 91.2 | 2.358 | | | |
| 16 | 147.2 | 1.461 | | | |
| 17 | 91.2 | 2.358 | | | |
| 18 | 147.2 | 1.461 | | | |
| 19 | 79.3 | 2.358 | | | |
| 20 | 128.0 | 1.461 | | | |
| 21 | 79.3 | 2.358 | | | |
| 22 | 128.0 | 1.461 | | | |
| 23 | 79.3 | 2.358 | | | |
| 24 | 128.0 | 1.461 | | | |
| 25 | 79.3 | 2.358 | | | |
| 26 | 128.0 | 1.461 | | | |
| 27 | 79.3 | 2.358 | | | |
| 28 | 128.0 | 1.461 | | | |
| 29 | 79.3 | 2.358 | | | |
| 30 | 128.0 | 1.461 | | | |
| 31 | 79.3 | 2.358 | | | |
| 32 | 128.0 | 1.461 | | | |
| 33 | 79.3 | 2.358 | | | |
| 34 | 128.0 | 1.461 | | | |
| 35 | 74.2 | 2.358 | | | |
| 36 | 119.7 | 1.461 | | | |
| 37 | 74.2 | 2.358 | | | |
| 38 | 119.7 | 1.461 | | | |
| 39 | 74.2 | 2.358 | | | |
| 40 | 119.7 | 1.461 | | | |
| 41 | 74.2 | 2.358 | | | |
| 42 | 119.7 | 1.461 | | | |
| 43 | 74.2 | 2.358 | | | |
| 44 | 119.7 | 1.461 | | | |
| 45 | 74.2 | 2.358 | | | |
| 46 | 119.7 | 1.461 | Dielectric | | |
| 47 | 74.2 | 2.358 | multilayer film | | |
| 48 | 119.7 | 1.461 | High refractive | | |
| 49 | 74.2 | 2.358 | index material + | | |
| 50 | 119.7 | 1.461 | Low refractive | | |
| 51 | 64.0 | 2.358 | index material | | |
| 52 | 103.3 | 1.461 | | | |
| 53 | 64.0 | 2.358 | | | |
| 54 | 103.3 | 1.461 | | | |
| 55 | 64.0 | 2.358 | | | |
| 56 | 103.3 | 1.461 | | | |
| 57 | 64.0 | 2.358 | | | |
| 58 | 103.3 | 1.461 | | | |
| 59 | 64.0 | 2.358 | | | |
| 60 | 103.3 | 1.461 | | | |
| 61 | 64.0 | 2.358 | | | |
| 62 | 103.3 | 1.461 | | | |
| 63 | 64.0 | 2.358 | | | |
| 64 | 103.3 | 1.461 | | | |
| 65 | 63.998454 | 2.358 | | | |
| 66 | 103.289232 | 1.461 | | | |
| 67 | 53.80401 | 2.358 | | | |
| 68 | 86.83608 | 1.461 | | | |
| 69 | 53.80401 | 2.358 | | | |
| 70 | 86.83608 | 1.461 | | | |
| 71 | 53.80401 | 2.358 | | | |
| 72 | 86.83608 | 1.461 | | | |
| 73 | 53.80401 | 2.358 | | | |
| 74 | 86.83608 | 1.461 | | | |
| 75 | 53.80401 | 2.358 | | | |
| 76 | 86.83608 | 1.461 | | | |
| 77 | 53.80401 | 2.358 | | | |
| 78 | 86.83608 | 1.461 | | | |
| 79 | 53.80401 | 2.358 | | | |
| 80 | 86.83608 | 1.461 | | | |
| 81 | 53.80401 | 2.358 | | | |
| 82 | 86.83608 | 1.461 | | | |
| 83 | 16.285875 | 2.358 | | | |
| 84 | 174.73665 | 1.461 | | | |
| | | 1.000 | Air | | |

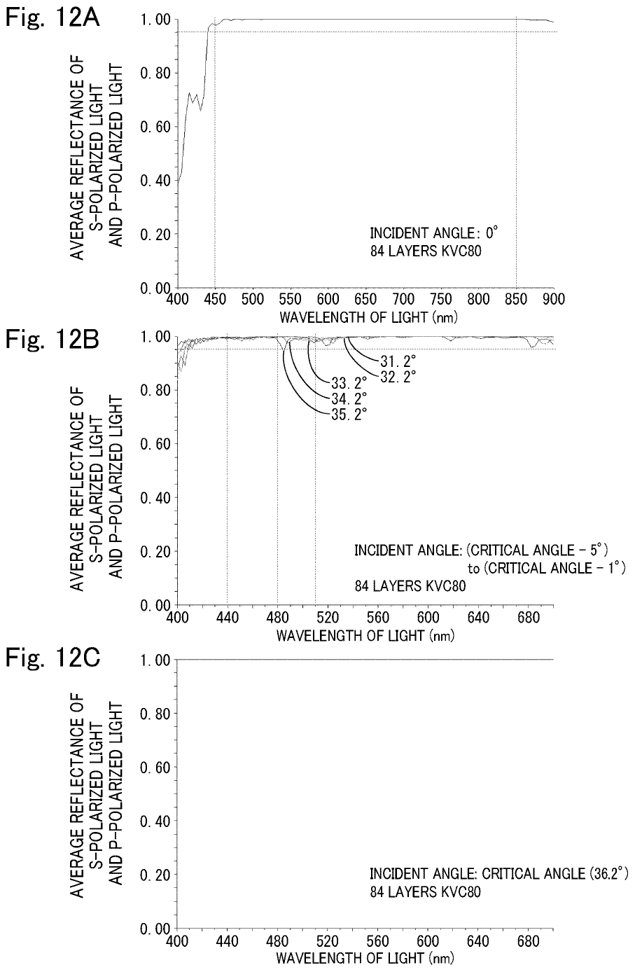

FIGS. 12A to 12C illustrate the reflectance spectrum characteristics of the dielectric multilayer film (Table 6, 84 layers) formed on glass KVC80. FIG. 12A illustrates the characteristics with an incident angle of 0° (normal incidence), FIG. 12B illustrates the characteristics with an incident angle of (critical angle −5°) to (critical angle −1°), and FIG. 12C illustrates the characteristics with an incident angle being the critical angle 36.2°.

### Numerical Example 2

For the optical system of Numerical Example 2 (corresponding to Example 2), the lens data is shown in Table 7, the aspherical shape data of the lens and the data of the object height and the image height in the optical path are shown in Table 8, and the free-form surface shape data of the prism is shown in Table 9. Specific configurations of the dielectric multilayer films formed on the first reflective surface R1 and/or the second reflective surface R2 of the prism are shown in Tables 10 to 12.

TABLE 7

| Reduction | Surface | | Radius of | Surface | | Refractive/ |
|---|---|---|---|---|---|---|
| side | number | Surface type | curvature | interval | Material | Reflective |
| SA | Object | | | 2.000 | | Refractive |
| PA | S1 | | ∞ | 34.600 | BK7_SCHOTT | Refractive |
| PA | S2 | | ∞ | 13.900 | | Refractive |
| L1 | S3 | | 33.131 | 12.825 | FCD100_HOYA | Refractive |
| L1 | S4 | | 262.410 | 0.399 | | Refractive |
| L2 | S5 | Aspherical | 42.274 | 11.291 | KSKLD5_SUMITA | Refractive |
| L2 | S6 | Aspherical | −85.752 | 10.561 | | Refractive |
| L3 | S7 | | −78.147 | 1.500 | SNBH52V_OHARA | Refractive |
| L3 | S8 | | 28.242 | 2.937 | | Refractive |
| L4 | S9 | | 34.812 | 9.226 | FCD100_HOYA | Refractive |
| L4 | S10 | | −39.314 | 12.289 | | Refractive |
| ST | S11 | Aperture stop | ∞ | 15.000 | | Refractive |
| | S12 | | ∞ | 60.555 | | Refractive |
| L5 | S13 | | 63.018 | 20.358 | FC5_HOYA | Refractive |
| L5 | S14 | | 258.405 | 17.202 | | Refractive |
| L6 | S15 | | 49.421 | 18.846 | TAFD5G_HOYA | Refractive |
| L6 | S16 | | 106.174 | 10.585 | | Refractive |
| L7 | S17 | | −212.890 | 3.000 | FDS90SG_HOYA | Refractive |
| L7 | S18 | | 147.363 | 9.011 | | Refractive |
| T1 | S19 | | 49.870 | 27.545 | KSKLD5_SUMITA | Refractive |
| R1 | S20 | | −49.269 | −22.437 | KSKLD5_SUMITA | Reflective |
| R2 | S21 | | −490.660 | 19.248 | KSKLD5_SUMITA | Reflective |
| T2 | S22 | | −185.512 | 1131.000 | | Refractive |
| SR | | | ∞ | 0.000 | | |
| Magnification | | | | | | |
| side | | | | | | |

| | Eccentricity type DAR |
|---|---|
| | Y eccentricity |
| S19 | −7.4814 |
| S20 | −17.6816 |
| S21 | −22.5385 |
| S22 | −0.9271 |

| | Aperture diameter |
|---|---|
| S7 | 26.03 |
| S10 | 24.38 |
| Aperture stop | 20.00 |
| S12 | 23.44 |

TABLE 8

| Aspheric coefficient | | |
|---|---|---|
| Surface number | S5 | S6 |
| Y radius of curvature | 42.274 | −85.752 |
| Conic constant | 0.000 | 0.000 |
| 4th order coefficient | −5.230E−06 | 3.400E−06 |
| 6th order coefficient | −4.257E−09 | −4.507E−09 |
| 8th order coefficient | −8.598E−12 | −1.386E−11 |
| 10th order coefficient | −1.659E−14 | 3.170E−15 |
| 12th order coefficient | 1.411E−18 | 1.675E−19 |
| 14th order coefficient | 7.860E−22 | −6.298E−22 |

| | |
|---|---|
| Object height | Image height |

| | X | Y | X | Y |
|---|---|---|---|---|
| f1 | 0.000 | −1.782 | 0.0 | −666.5 |
| f2 | 0.000 | −14.418 | 0.0 | −3037.5 |
| f3 | 4.320 | −1.782 | 817.4 | −662.1 |
| f4 | 4.320 | −14.418 | 813.0 | −3042.3 |
| f5 | 8.640 | −1.782 | 1615.7 | −666.8 |
| f6 | 8.640 | −14.418 | 1611.7 | −3047.0 |
| f7 | −4.320 | −1.782 | −817.4 | −662.1 |
| f8 | −4.320 | −14.418 | −813.0 | −3042.3 |
| f9 | −8.640 | −1.782 | −1615.7 | −666.8 |
| f10 | −8.640 | −14.418 | −1611.7 | −3047.0 |

TABLE 9
XY polynomial surface coefficient

| | Conic constant | 0.000 | | | | | | | | | |
|---|---|---|---|---|---|---|---|---|---|---|---|
| S19 | X**0 | X**1 | X**2 | X**3 | X**4 | X**5 | X**6 | X**7 | X**8 | X**9 | X**10 |
| Y**0 | | 0.00000E+00 | −4.51232E−02 | 0.00000E+00 | 1.35857E−04 | 0.00000E+00 | −4.45171E−07 | 0.00000E+00 | 5.13990E−10 | 0.00000E+00 | 2.69573E−13 |
| Y**1 | 1.70199E+00 | 0.00000E+00 | 1.59886E−03 | 0.00000E+00 | −8.11641E−06 | 0.00000E+00 | 2.78629E−08 | 0.00000E+00 | −5.33101E−11 | 0.00000E+00 | |
| Y**2 | −2.14722E−01 | 0.00000E+00 | 3.07680E−05 | 0.00000E+00 | 2.68619E−07 | 0.00000E+00 | −1.22398E−10 | 0.00000E+00 | 7.94657E−13 | | |
| Y**3 | 1.19943E−02 | 0.00000E+00 | −5.12370E−06 | 0.00000E+00 | −8.81852E−09 | 0.00000E+00 | −3.20465E−12 | 0.00000E+00 | | | |
| Y**4 | −2.71212E−04 | 0.00000E+00 | 7.97778E−08 | 0.00000E+00 | −4.70932E−11 | 0.00000E+00 | −2.92320E−14 | | | | |
| Y**5 | −3.58557E−06 | 0.00000E+00 | 1.03906E−08 | 0.00000E+00 | 5.54750E−12 | 0.00000E+00 | | | | | |
| Y**6 | 2.32955E−07 | 0.00000E+00 | −4.02664E−10 | 0.00000E+00 | −2.47691E−14 | | | | | | |
| Y**7 | 2.26325E−10 | 0.00000E+00 | 1.86687E−12 | 0.00000E+00 | | | | | | | |
| Y**8 | −9.36027E−11 | 0.00000E+00 | 5.49138E−14 | | | | | | | | |
| Y**9 | 3.59240E−15 | 0.00000E+00 | | | | | | | | | |
| Y**10 | 1.82737E−14 | | | | | | | | | | |

| | Conic constant | 0.000 | | | | | | | | | |
|---|---|---|---|---|---|---|---|---|---|---|---|
| S20 | X**0 | X**1 | X**2 | X**3 | X**4 | X**5 | X**6 | X**7 | X**8 | X**9 | X**10 |
| Y**0 | | 0.000000E+00 | −1.037353E−02 | 0.000000E+00 | 1.790228E−05 | 0.000000E+00 | 2.851158E−08 | 0.000000E+00 | −3.444582E−11 | 0.000000E+00 | 2.648337E−15 |
| Y**1 | 1.234678E+00 | 0.000000E+00 | 2.822729E−04 | 0.000000E+00 | −1.958624E−06 | 0.000000E+00 | −2.334166E−09 | 0.000000E+00 | 2.500833E−12 | 0.000000E+00 | |
| Y**2 | −7.414465E−02 | 0.000000E+00 | 1.713386E−05 | 0.000000E+00 | 6.879739E−08 | 0.000000E+00 | 6.416173E−11 | 0.000000E+00 | −5.179506E−14 | | |
| Y**3 | 2.631165E−03 | 0.000000E+00 | −1.366684E−06 | 0.000000E+00 | 4.718794E−10 | 0.000000E+00 | −4.945307E−13 | 0.000000E+00 | | | |
| Y**4 | −3.571804E−05 | 0.000000E+00 | 2.843045E−08 | 0.000000E+00 | −5.552895E−11 | 0.000000E+00 | 1.682256E−15 | | | | |
| Y**5 | −2.953638E−07 | 0.000000E+00 | 7.799891E−11 | 0.000000E+00 | 4.640906E−13 | 0.000000E+00 | | | | | |
| Y**6 | 1.160810E−08 | 0.000000E+00 | −1.098915E−12 | 0.000000E+00 | 6.631821E−15 | | | | | | |
| Y**7 | −2.160768E−11 | 0.000000E+00 | −1.974356E−13 | 0.000000E+00 | | | | | | | |
| Y**8 | −4.659420E−13 | 0.000000E+00 | 3.243665E−15 | | | | | | | | |
| Y**9 | −8.797581E−15 | 0.000000E+00 | | | | | | | | | |
| Y**10 | 1.415358E−16 | | | | | | | | | | |

| | Conic constant | 0.000 | | | | | | | | | |
|---|---|---|---|---|---|---|---|---|---|---|---|
| S21 | X**0 | X**1 | X**2 | X**3 | X**4 | X**5 | X**6 | X**7 | X**8 | X**9 | X**10 |
| Y**0 | | 0.000000E+00 | 1.795163E−03 | 0.000000E+00 | 0.000000E+00 | 0.000000E+00 | 0.000000E+00 | 0.000000E+00 | 0.000000E+00 | 0.000000E+00 | 0.000000E+00 |
| Y**1 | 1.753246E−02 | 0.000000E+00 | 1.936757E−05 | 0.000000E+00 | 0.000000E+00 | 0.000000E+00 | 0.000000E+00 | 0.000000E+00 | 0.000000E+00 | 0.000000E+00 | |
| Y**2 | 1.425184E−03 | 0.000000E+00 | −5.037589E−06 | 0.000000E+00 | 0.000000E+00 | 0.000000E+00 | 0.000000E+00 | 0.000000E+00 | 0.000000E+00 | | |
| Y**3 | −1.042475E−06 | 0.000000E+00 | 1.282708E−06 | 0.000000E+00 | 0.000000E+00 | 0.000000E+00 | 0.000000E+00 | 0.000000E+00 | | | |
| Y**4 | 5.048197E−07 | 0.000000E+00 | −1.456463E−07 | 0.000000E+00 | 0.000000E+00 | 0.000000E+00 | 0.000000E+00 | | | | |
| Y**5 | 2.157347E−08 | 0.000000E+00 | 8.424055E−09 | 0.000000E+00 | 0.000000E+00 | 0.000000E+00 | | | | | |
| Y**6 | −1.730532E−09 | 0.000000E+00 | −2.195251E−10 | 0.000000E+00 | 0.000000E+00 | | | | | | |
| Y**7 | 6.088994E−11 | 0.000000E+00 | 4.906280E−13 | 0.000000E+00 | | | | | | | |
| Y**8 | −1.622195E−12 | 0.000000E+00 | 5.448728E−14 | | | | | | | | |
| Y**9 | −4.246610E−14 | 0.000000E+00 | | | | | | | | | |
| Y**10 | 2.539740E−15 | | | | | | | | | | |

| | Conic constant | 0.000 | | | | | | | | | |
|---|---|---|---|---|---|---|---|---|---|---|---|
| S22 | X**0 | X**1 | X**2 | X**3 | X**4 | X**5 | X**6 | X**7 | X**8 | X**9 | X**10 |
| Y**0 | | 0.000000E+00 | −3.334127E−03 | 0.000000E+00 | −4.824312E−06 | 0.000000E+00 | −1.813818E−08 | 0.000000E+00 | 7.825476E−12 | 0.000000E+00 | 4.022838E−15 |
| Y**1 | −6.629174E−01 | 0.000000E+00 | 1.397858E−03 | 0.000000E+00 | −1.581567E−06 | 0.000000E+00 | −1.278648E−09 | 0.000000E+00 | 1.193801E−12 | 0.000000E+00 | |
| Y**2 | −5.793506E−02 | 0.000000E+00 | 1.017961E−04 | 0.000000E+00 | −1.120055E−07 | 0.000000E+00 | −1.167851E−11 | 0.000000E+00 | 1.612975E−14 | | |
| Y**3 | −1.452413E−03 | 0.000000E+00 | 1.601087E−06 | 0.000000E+00 | 1.864343E−11 | 0.000000E+00 | −1.209792E−12 | 0.000000E+00 | | | |
| Y**4 | −4.065152E−06 | 0.000000E+00 | −5.652550E−08 | 0.000000E+00 | 1.014085E−10 | 0.000000E+00 | −5.307892E−14 | | | | |
| Y**5 | 7.507642E−08 | 0.000000E+00 | 1.409569E−10 | 0.000000E+00 | −3.744850E−13 | 0.000000E+00 | | | | | |
| Y**6 | −1.902032E−08 | 0.000000E+00 | 6.963631E−11 | 0.000000E+00 | −5.535630E−14 | | | | | | |
| Y**7 | 1.035314E−10 | 0.000000E+00 | 1.196417E−13 | 0.000000E+00 | | | | | | | |
| Y**8 | 1.909470E−11 | 0.000000E+00 | −2.274701E−14 | | | | | | | | |
| Y**9 | 3.616362E−14 | 0.000000E+00 | | | | | | | | | |
| Y**10 | −4.831731E−15 | | | | | | | | | | |

TABLE 10
Multilayer film example 1
Examples 2 and 3 Reflective surface coating

| | | Refractive index | | | |
|---|---|---|---|---|---|
| | Film thickness | | Prism | Critical | |
| | [nm] | 1.58913 | KSKLD5_SUMTA | angle | 39.0 |
| 1 | 77.2 | 2.358 | Dielectric | −1 | 38.0 |
| 2 | 89.0 | 1.461 | multilayer film | −2 | 37.0 |
| 3 | 87.1 | 2.358 | High refractive | −3 | 36.0 |
| 4 | 140.6 | 1.461 | index material + | −4 | 35.0 |
| 5 | 87.1 | 2.358 | Low refractive | −5 | 34.0 |
| 6 | 140.6 | 1.461 | index material | | |
| 7 | 87.1 | 2.358 | | | |
| 8 | 140.6 | 1.461 | | | |
| 9 | 87.1 | 2.358 | | | |
| 10 | 140.6 | 1.461 | | | |
| 11 | 87.1 | 2.358 | | | |
| 12 | 140.6 | 1.461 | | | |
| 13 | 87.1 | 2.358 | | | |
| 14 | 140.6 | 1.461 | | | |
| 15 | 81.0 | 2.358 | | | |
| 16 | 130.8 | 1.461 | | | |
| 17 | 81.0 | 2.358 | | | |
| 18 | 130.8 | 1.461 | | | |
| 19 | 81.0 | 2.358 | | | |
| 20 | 130.8 | 1.461 | | | |
| 21 | 81.0 | 2.358 | | | |
| 22 | 130.8 | 1.461 | | | |
| 23 | 81.0 | 2.358 | | | |
| 24 | 130.8 | 1.461 | | | |
| 25 | 81.0 | 2.358 | | | |
| 26 | 130.8 | 1.461 | | | |
| 27 | 70.6 | 2.358 | | | |
| 28 | 113.9 | 1.461 | | | |
| 29 | 70.6 | 2.358 | | | |
| 30 | 113.9 | 1.461 | | | |
| 31 | 70.6 | 2.358 | | | |
| 32 | 113.9 | 1.461 | | | |
| 33 | 70.6 | 2.358 | | | |
| 34 | 113.9 | 1.461 | | | |
| 35 | 70.6 | 2.358 | | | |
| 36 | 113.9 | 1.461 | | | |
| 37 | 70.6 | 2.358 | | | |
| 38 | 113.9 | 1.461 | | | |
| 39 | 62.8 | 2.358 | | | |
| 40 | 101.4 | 1.461 | | | |
| 41 | 62.8 | 2.358 | | | |
| 42 | 101.4 | 1.461 | | | |
| 43 | 62.8 | 2.358 | | | |
| 44 | 101.4 | 1.461 | | | |
| 45 | 62.8 | 2.358 | | | |
| 46 | 101.4 | 1.461 | Dielectric | | |
| 47 | 62.8 | 2.358 | multilayer film | | |
| 48 | 101.4 | 1.461 | High refractive | | |
| 49 | 62.8 | 2.358 | index material + | | |
| 50 | 101.4 | 1.461 | Low refractive | | |
| 51 | 52.4 | 2.358 | index material | | |
| 52 | 84.5 | 1.461 | | | |
| 53 | 52.4 | 2.358 | | | |
| 54 | 84.5 | 1.461 | | | |
| 55 | 52.4 | 2.358 | | | |
| 56 | 84.5 | 1.461 | | | |
| 57 | 52.4 | 2.358 | | | |
| 58 | 84.5 | 1.461 | | | |
| 59 | 52.4 | 2.358 | | | |
| 60 | 84.5 | 1.461 | | | |
| 61 | 52.4 | 2.358 | | | |
| 62 | 84.5 | 1.461 | | | |
| 63 | 66.2 | 2.358 | | | |
| 64 | 124.6 | 1.461 | | | |
| | | 1.000 | Air | | |

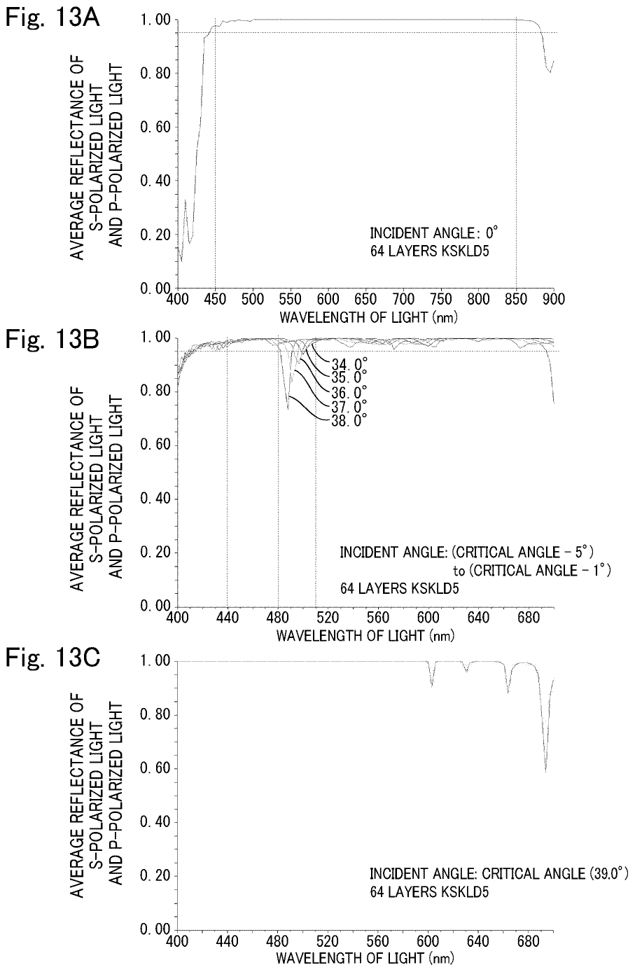

FIGS. 13A to 13C illustrate the reflectance spectrum characteristics of the dielectric multilayer film (Table 10, 64 layers) formed on glass KSKLD5. FIG. 13A illustrates the characteristics with an incident angle of 0° (normal incidence), FIG. 13B illustrates a characteristic with an incident angle of (critical angle −5°) to (critical angle −1°), and FIG. 13C illustrates the characteristics with the incident angle being the critical angle 39.0°.

TABLE 11
Multilayer film example 2
Example 2 Reflective surface coating

| | | Refractive index | | | |
|---|---|---|---|---|---|
| | Film thickness | | Prism | Critical | |
| | [nm] | 1.589 | KSKLD5_SUMTA | angle | 39.0 |
| 1 | 88.2 | 2.358 | Dielectric | −1 | 38.0 |
| 2 | 124.6 | 1.461 | multilayer film | −2 | 37.0 |
| 3 | 88.2 | 2.358 | High refractive | −3 | 36.0 |
| 4 | 142.3 | 1.461 | index material + | −4 | 35.0 |
| 5 | 88.2 | 2.358 | Low refractive | −5 | 34.0 |
| 6 | 142.3 | 1.461 | index material | | |
| 7 | 88.2 | 2.358 | | | |
| 8 | 142.3 | 1.461 | | | |
| 9 | 88.2 | 2.358 | | | |
| 10 | 142.3 | 1.461 | | | |
| 11 | 88.2 | 2.358 | | | |
| 12 | 142.3 | 1.461 | | | |
| 13 | 83.8 | 2.358 | | | |
| 14 | 135.2 | 1.461 | | | |
| 15 | 83.8 | 2.358 | | | |
| 16 | 135.2 | 1.461 | | | |
| 17 | 83.8 | 2.358 | | | |
| 18 | 135.2 | 1.461 | | | |
| 19 | 83.8 | 2.358 | | | |
| 20 | 135.2 | 1.461 | | | |
| 21 | 83.8 | 2.358 | | | |
| 22 | 135.2 | 1.461 | | | |
| 23 | 70.6 | 2.358 | | | |
| 24 | 113.9 | 1.461 | | | |
| 25 | 70.6 | 2.358 | | | |
| 26 | 113.9 | 1.461 | | | |
| 27 | 70.6 | 2.358 | | | |
| 28 | 113.9 | 1.461 | | | |
| 29 | 70.6 | 2.358 | | | |
| 30 | 113.9 | 1.461 | | | |
| 31 | 70.6 | 2.358 | | | |
| 32 | 113.9 | 1.461 | | | |
| 33 | 62.3 | 2.358 | | | |
| 34 | 100.5 | 1.461 | | | |
| 35 | 62.3 | 2.358 | | | |
| 36 | 100.5 | 1.461 | | | |
| 37 | 62.3 | 2.358 | | | |
| 38 | 100.5 | 1.461 | | | |
| 39 | 62.3 | 2.358 | | | |
| 40 | 100.5 | 1.461 | | | |
| 41 | 62.3 | 2.358 | | | |
| 42 | 100.5 | 1.461 | | | |
| 43 | 50.7 | 2.358 | | | |
| 44 | 81.8 | 1.461 | | | |
| 45 | 50.7 | 2.358 | | | |
| 46 | 81.8 | 1.461 | Dielectric | | |
| 47 | 50.7 | 2.358 | multilayer film | | |
| 48 | 81.8 | 1.461 | High refractive | | |
| 49 | 50.7 | 2.358 | index material + | | |
| 50 | 81.8 | 1.461 | Low refractive | | |
| 51 | 50.7 | 2.358 | index material | | |
| 52 | 81.8 | 1.461 | | | |
| 53 | 66.2 | 2.358 | | | |
| 54 | 124.6 | 1.461 | | | |
| | | 1.000 | Air | | |

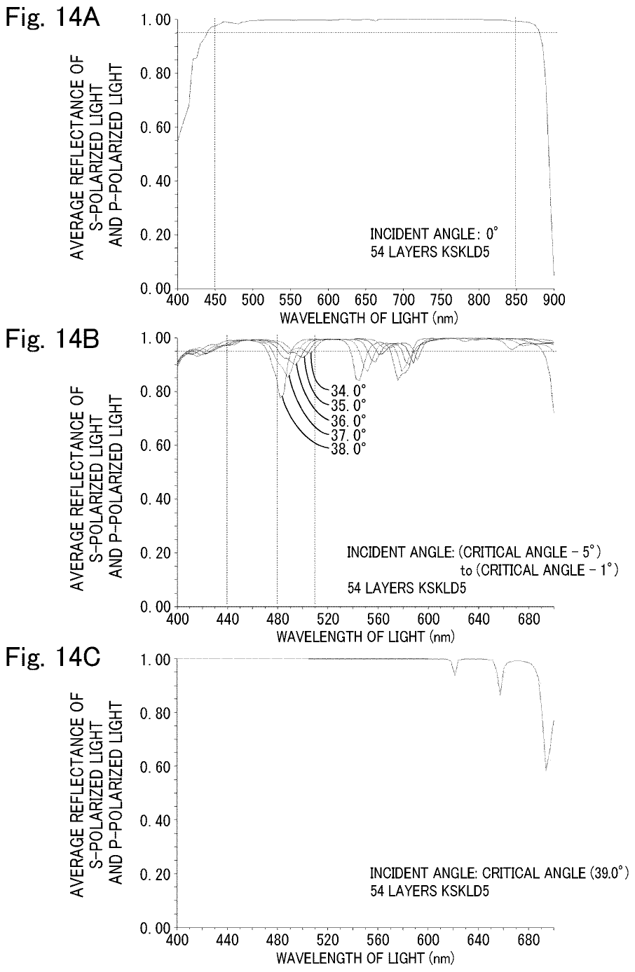

FIGS. 14A to 14C illustrate the reflectance spectrum characteristics of the dielectric multilayer film (Table 11, 54 layers) formed on glass KSKLD5. FIG. 14A illustrates the characteristics with an incident angle of 0° (normal incidence), FIG. 14B illustrates the characteristics with an incident angle of (critical angle −5°) to (critical angle −1°), and FIG. 14C illustrates the characteristics with an incident angle being the critical angle 39.0°.

TABLE 12
Multilayer film example 3
Example 2 Reflective surface coating

| | | Refractive index | | | |
|---|---|---|---|---|---|
| | Film thickness | | Prism | Critical | |
| | [nm] | 1.589 | KSKLD5_SUMTA | angle | 39.0 |
| 1 | 51.6 | 2.358 | Dielectric | −1 | 38.0 |
| 2 | 115.7 | 1.461 | multilayer film | −2 | 37.0 |
| 3 | 91.2 | 2.358 | High refractive | −3 | 36.0 |
| 4 | 147.2 | 1.461 | index material + | −4 | 35.0 |
| 5 | 91.2 | 2.358 | Low refractive | −5 | 34.0 |
| 6 | 147.2 | 1.461 | index material | | |
| 7 | 91.2 | 2.358 | | | |
| 8 | 147.2 | 1.461 | | | |
| 9 | 91.2 | 2.358 | | | |
| 10 | 147.2 | 1.461 | | | |
| 11 | 91.2 | 2.358 | | | |
| 12 | 147.2 | 1.461 | | | |
| 13 | 91.2 | 2.358 | | | |
| 14 | 147.2 | 1.461 | | | |
| 15 | 91.2 | 2.358 | | | |
| 16 | 147.2 | 1.461 | | | |
| 17 | 91.2 | 2.358 | | | |
| 18 | 147.2 | 1.461 | | | |
| 19 | 79.3 | 2.358 | | | |
| 20 | 128.0 | 1.461 | | | |
| 21 | 79.3 | 2.358 | | | |
| 22 | 128.0 | 1.461 | | | |
| 23 | 79.3 | 2.358 | | | |
| 24 | 128.0 | 1.461 | | | |
| 25 | 79.3 | 2.358 | | | |
| 26 | 128.0 | 1.461 | | | |
| 27 | 79.3 | 2.358 | | | |
| 28 | 128.0 | 1.461 | | | |
| 29 | 79.3 | 2.358 | | | |
| 30 | 128.0 | 1.461 | | | |
| 31 | 79.3 | 2.358 | | | |
| 32 | 128.0 | 1.461 | | | |
| 33 | 79.3 | 2.358 | | | |
| 34 | 128.0 | 1.461 | | | |
| 35 | 74.2 | 2.358 | | | |
| 36 | 119.7 | 1.461 | | | |
| 37 | 74.2 | 2.358 | | | |
| 38 | 119.7 | 1.461 | | | |
| 39 | 74.2 | 2.358 | | | |
| 40 | 119.7 | 1.461 | | | |
| 41 | 74.2 | 2.358 | | | |
| 42 | 119.7 | 1.461 | | | |
| 43 | 74.2 | 2.358 | | | |
| 44 | 119.7 | 1.461 | | | |
| 45 | 74.2 | 2.358 | | | |
| 46 | 119.7 | 1.461 | Dielectric | | |
| 47 | 74.2 | 2.358 | multilayer film | | |
| 48 | 119.7 | 1.461 | High refractive | | |
| 49 | 74.2 | 2.358 | index material + | | |
| 50 | 119.7 | 1.461 | Low refractive | | |
| 51 | 64.0 | 2.358 | index material | | |
| 52 | 103.3 | 1.461 | | | |
| 53 | 64.0 | 2.358 | | | |
| 54 | 103.3 | 1.461 | | | |
| 55 | 64.0 | 2.358 | | | |
| 56 | 103.3 | 1.461 | | | |
| 57 | 64.0 | 2.358 | | | |
| 58 | 103.3 | 1.461 | | | |
| 59 | 64.0 | 2.358 | | | |
| 60 | 103.3 | 1.461 | | | |
| 61 | 64.0 | 2.358 | | | |
| 62 | 103.3 | 1.461 | | | |
| 63 | 64.0 | 2.358 | | | |
| 64 | 103.3 | 1.461 | | | |
| 65 | 63.998454 | 2.358 | | | |
| 66 | 103.289232 | 1.461 | | | |
| 67 | 53.80401 | 2.358 | | | |
| 68 | 86.83608 | 1.461 | | | |
| 69 | 53.80401 | 2.358 | | | |
| 70 | 86.83608 | 1.461 | | | |
| 71 | 53.80401 | 2.358 | | | |
| 72 | 86.83608 | 1.461 | | | |
| 73 | 53.80401 | 2.358 | | | |
| 74 | 86.83608 | 1.461 | | | |
| 75 | 53.80401 | 2.358 | | | |
| 76 | 86.83608 | 1.461 | | | |
| 77 | 53.80401 | 2.358 | | | |
| 78 | 86.83608 | 1.461 | | | |
| 79 | 53.80401 | 2.358 | | | |
| 80 | 86.83608 | 1.461 | | | |
| 81 | 53.80401 | 2.358 | | | |
| 82 | 86.83608 | 1.461 | | | |
| 83 | 16.285875 | 2.358 | | | |
| 84 | 174.73665 | 1.461 | | | |
| | | 1.000 | Air | | |

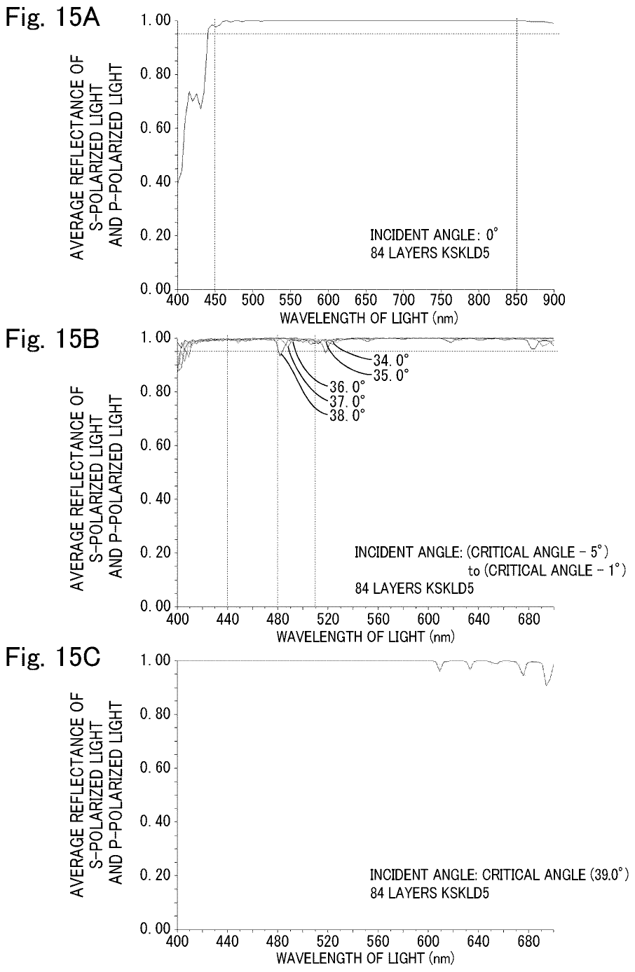

FIGS. 15A to 15C illustrate the reflectance spectrum characteristics of the dielectric multilayer film (Table 12, 84 layers) formed on glass KSKLD5. FIG. 15A illustrates the characteristics with an incident angle of 0° (normal incidence), FIG. 15B illustrates the characteristics with an incident angle of (critical angle −5°) to (critical angle −1°), and FIG. 15C illustrates the characteristics with an incident angle being the critical angle of 39.0°.

### Numerical Example 3

For the optical system of Numerical Example 3 (corresponding to Example 3), the lens data is shown in Table 13, the aspherical shape data of the lens and the data of the object height and the image height in the optical path are shown in Table 14, and the free-form surface shape data of the prism is shown in Table 15. The specific configuration of the dielectric multilayer film formed on the first reflective surface R1 and/or the second reflective surface R2 of the prism is the same as that of the dielectric multilayer film (64 layers) shown in Table 10.

TABLE 13

| Reduction | Surface | | Radius of | Surface | | Refractive/ |
|---|---|---|---|---|---|---|
| side | number | Surface type | curvature | interval | Material | Reflective |
| SA | Object | | | 2.000 | | Refractive |
| PA | S1 | | ∞ | 34.600 | BK7_SCHOTT | Refractive |
| PA | S2 | | ∞ | 13.900 | | Refractive |
| L1 | S3 | | 33.131 | 12.825 | FCD100_HOYA | Refractive |
| L1 | S4 | | 262.410 | 0.399 | | Refractive |
| L2 | S5 | Aspherical | 42.016 | 11.291 | KSKLD5_SUMITA | Refractive |
| L2 | S6 | Aspherical | −89.227 | 10.561 | | Refractive |
| L3 | S7 | | −78.147 | 1.500 | SNBH52V_OHARA | Refractive |
| L3 | S8 | | 28.242 | 2.937 | | Refractive |
| L4 | S9 | | 34.812 | 9.226 | FCD100_HOYA | Refractive |
| L4 | S10 | | −39.314 | 12.289 | | Refractive |
| ST | S11 | Aperture | ∞ | 15.000 | | Refractive |
| | | stop | | | | |
| | S12 | | ∞ | 55.998 | | Refractive |
| L5 | S13 | | 67.919 | 12.734 | TAC8_HOYA | Refractive |
| L5 | S14 | | 426.579 | 12.636 | | Refractive |
| L6 | S15 | | 47.109 | 10.600 | BAFD7_HOYA | Refractive |
| L6 | S16 | | 67.161 | 7.872 | | Refractive |
| L7 | S17 | | 1205.078 | 3.000 | FDS90SG_HOYA | Refractive |
| L7 | S18 | | 76.961 | 32.297 | | Refractive |
| T1 | S19 | | 33.184 | 26.098 | KSKLD5_SUMITA | Refractive |
| R1 | S20 | | −90.387 | −25.627 | KSKLD5_SUMITA | Reflective |
| R2 | S21 | | −1377.094 | 27.235 | KSKLD5_SUMITA | Reflective |
| T2 | S22 | | 511.333 | 1131.000 | | Refractive |
| SR | | | ∞ | 0.000 | | |
| Magnification | | | | | | |
| side | | | | | | |

Eccentricity type DAR

| | Y | Z |
|---|---|---|
| | eccentricity | eccentricity |
| S19 | −0.2784 | |
| S20 | −0.0593 | |
| S21 | −7.0610 | |
| S22 | 1.6405 | |

| | Aperture diameter |
|---|---|
| S7 | 26.03 |
| S10 | 24.38 |
| Aperture stop | 21.19 |
| S12 | 23.44 |

TABLE 14

| Aspheric coefficient | | |
|---|---|---|
| Surface number | S5 | S6 |
| Y radius of curvature | 42.016 | −89.227 |
| Conic constant | 0.000 | 0.000 |
| 4th order coefficient | −5.521E−06 | 2.970E−06 |
| 6th order coefficient | −4.289E−09 | −4.216E−09 |
| 8th order coefficient | −8.231E−12 | −1.454E−11 |
| 10th order coefficient | −1.784E−14 | 2.313E−15 |

| | |
|---|---|
| Object height | Image height |

| | X | Y | X | Y |
|---|---|---|---|---|
| f1 | 0.000 | −1.782 | 0.0 | 0.0 |
| f2 | 0.000 | −14.418 | 0.0 | −2379.1 |
| f3 | 4.320 | −1.782 | 781.1 | −4.8 |
| f4 | 4.320 | −14.418 | 787.2 | −2383.9 |
| f5 | 8.640 | −1.782 | 1615.7 | 0.0 |
| f6 | 8.640 | −14.418 | 1607.6 | −2388.6 |
| f7 | −4.320 | −1.782 | −781.1 | −4.8 |
| f8 | −4.320 | −14.418 | −787.2 | −2383.9 |
| f9 | −8.640 | −1.782 | −1615.7 | 0.0 |
| f10 | −8.640 | −14.418 | −1607.6 | −2388.6 |

TABLE 15
XY polynomial surface coefficient

| | Conic constant | 0.000 | | | | | | | | | |
|---|---|---|---|---|---|---|---|---|---|---|---|
| S19 | X**0 | X**1 | X**2 | X**3 | X**4 | X**5 | X**6 | X**7 | X**8 | X**9 | X**10 |
| Y**0 | | 0.00000E+00 | −2.03498E−02 | 0.00000E+00 | 1.38338E−04 | 0.00000E+00 | −1.01977E−06 | 0.00000E+00 | 2.62442E−09 | 0.00000E+00 | −2.15000E−12 |
| Y**1 | 2.81558E−01 | 0.00000E+00 | 0.00000E+00 | 0.00000E+00 | 0.00000E+00 | 0.00000E+00 | 0.00000E+00 | 0.00000E+00 | 0.00000E+00 | 0.00000E+00 | |
| Y**2 | −3.34041E−02 | 0.00000E+00 | 4.85643E−05 | 0.00000E+00 | −3.90177E−07 | 0.00000E+00 | 1.74537E−09 | 0.00000E+00 | −2.42802E−12 | | |
| Y**3 | 0.00000E+00 | 0.00000E+00 | 0.00000E+00 | 0.00000E+00 | 0.00000E+00 | 0.00000E+00 | 0.00000E+00 | 0.00000E+00 | | | |
| Y**4 | 2.01886E−05 | 0.00000E+00 | −6.60533E−08 | 0.00000E+00 | 1.47383E−10 | 0.00000E+00 | −2.15847E−13 | | | | |
| Y**5 | 0.00000E+00 | 0.00000E+00 | 0.00000E+00 | 0.00000E+00 | 0.00000E+00 | 0.00000E+00 | | | | | |
| Y**6 | −3.30413E−09 | 0.00000E+00 | 8.63807E−11 | 0.00000E+00 | −1.58892E−13 | | | | | | |
| Y**7 | 0.00000E+00 | 0.00000E+00 | 0.00000E+00 | 0.00000E+00 | | | | | | | |
| Y**8 | −2.07743E−11 | 0.00000E+00 | −6.45909E−14 | | | | | | | | |
| Y**9 | 0.00000E+00 | 0.00000E+00 | | | | | | | | | |
| Y**10 | 1.08988E−14 | | | | | | | | | | |
| | Conic constant | 0.000 | | | | | | | | | |
| S20 | X**0 | X**1 | X**2 | X**3 | X**4 | X**5 | X**6 | X**7 | X**8 | X**9 | X**10 |
| Y**0 | | 0.000000E+00 | −9.873857E−03 | 0.000000E+00 | −1.385179E−05 | 0.000000E+00 | 8.586710E−08 | 0.000000E+00 | −1.698864E−10 | 0.000000E+00 | 1.201862E−13 |
| Y**1 | 6.342021E−02 | 0.000000E+00 | 0.000000E+00 | 0.000000E+00 | 0.000000E+00 | 0.000000E+00 | 0.000000E+00 | 0.000000E+00 | 0.000000E+00 | 0.000000E+00 | |
| Y**2 | −1.112817E−02 | 0.000000E+00 | −2.594689E−06 | 0.000000E+00 | 5.167210E−08 | 0.000000E+00 | −1.635589E−10 | 0.000000E+00 | 1.714441E−13 | | |
| Y**3 | 0.000000E+00 | 0.000000E+00 | 0.000000E+00 | 0.000000E+00 | 0.000000E+00 | 0.000000E+00 | 0.000000E+00 | 0.000000E+00 | | | |
| Y**4 | −6.554819E−07 | 0.000000E+00 | 1.415707E−08 | 0.000000E+00 | −2.115627E−11 | 0.000000E+00 | 5.814122E−14 | | | | |
| Y**5 | 0.000000E+00 | 0.000000E+00 | 0.000000E+00 | 0.000000E+00 | 0.000000E+00 | 0.000000E+00 | | | | | |
| Y**6 | 7.495925E−09 | 0.000000E+00 | −2.429164E−12 | 0.000000E+00 | −1.369415E−14 | | | | | | |
| Y**7 | 0.000000E+00 | 0.000000E+00 | 0.000000E+00 | 0.000000E+00 | | | | | | | |
| Y**8 | −5.841121E−12 | 0.000000E+00 | −1.908774E−15 | | | | | | | | |
| Y**9 | 0.000000E+00 | 0.000000E+00 | | | | | | | | | |
| Y**10 | 1.871454E−15 | | | | | | | | | | |

| | Conic constant | 0.000 | | | | | | | | | |
|---|---|---|---|---|---|---|---|---|---|---|---|
| S21 | X**0 | X**1 | X**2 | X**3 | X**4 | X**5 | X**6 | X**7 | X**8 | X**9 | X**10 |
| Y**0 | | 0.000000E+00 | 8.015010E−04 | 0.000000E+00 | 0.000000E+00 | 0.000000E+00 | 0.000000E+00 | 0.000000E+00 | 0.000000E+00 | 0.000000E+00 | 0.000000E+00 |
| Y**1 | −4.583491E−02 | 0.000000E+00 | 0.000000E+00 | 0.000000E+00 | 0.000000E+00 | 0.000000E+00 | 0.000000E+00 | 0.000000E+00 | 0.000000E+00 | 0.000000E+00 | |
| Y**2 | 1.004320E−03 | 0.000000E+00 | −4.720371E−07 | 0.000000E+00 | 0.000000E+00 | 0.000000E+00 | 0.000000E+00 | 0.000000E+00 | 0.000000E+00 | | |
| Y**3 | 0.000000E+00 | 0.000000E+00 | 0.000000E+00 | 0.000000E+00 | 0.000000E+00 | 0.000000E+00 | 0.000000E+00 | 0.000000E+00 | | | |
| Y**4 | 0.000000E+00 | 0.000000E+00 | 0.000000E+00 | 0.000000E+00 | 0.000000E+00 | 0.000000E+00 | 0.000000E+00 | | | | |
| Y**5 | 0.000000E+00 | 0.000000E+00 | 0.000000E+00 | 0.000000E+00 | 0.000000E+00 | 0.000000E+00 | | | | | |
| Y**6 | 0.000000E+00 | 0.000000E+00 | 0.000000E+00 | 0.000000E+00 | 0.000000E+00 | | | | | | |
| Y**7 | 0.000000E+00 | 0.000000E+00 | 0.000000E+00 | 0.000000E+00 | | | | | | | |
| Y**8 | 0.000000E+00 | 0.000000E+00 | 0.000000E+00 | | | | | | | | |
| Y**9 | 0.000000E+00 | 0.000000E+00 | | | | | | | | | |
| Y**10 | 0.000000E+00 | | | | | | | | | | |

| | Conic constant | 0.000 | | | | | | | | | |
|---|---|---|---|---|---|---|---|---|---|---|---|
| S22 | X**0 | X**1 | X**2 | X**3 | X**4 | X**5 | X**6 | X**7 | X**8 | X**9 | X**10 |
| Y**0 | | 0.000000E+00 | −1.403764E−02 | 0.000000E+00 | −1.863848E−06 | 0.000000E+00 | −9.670662E−10 | 0.000000E+00 | 1.659321E−13 | 0.000000E+00 | −7.274824E−16 |
| Y**1 | 2.684008E−02 | 0.000000E+00 | 0.000000E+00 | 0.000000E+00 | 0.000000E+00 | 0.000000E+00 | 0.000000E+00 | 0.000000E+00 | 0.000000E+00 | 0.000000E+00 | |
| Y**2 | −1.632274E−02 | 0.000000E+00 | 4.280294E−06 | 0.000000E+00 | −2.500063E−08 | 0.000000E+00 | 2.876408E−11 | 0.000000E+00 | −1.602007E−14 | | |
| Y**3 | 0.000000E+00 | 0.000000E+00 | 0.000000E+00 | 0.000000E+00 | 0.000000E+00 | 0.000000E+00 | 0.000000E+00 | 0.000000E+00 | | | |
| Y**4 | 6.324324E−06 | 0.000000E+00 | −2.824800E−08 | 0.000000E+00 | 5.063616E−11 | 0.000000E+00 | −3.896341E−14 | | | | |
| Y**5 | 0.000000E+00 | 0.000000E+00 | 0.000000E+00 | 0.000000E+00 | 0.000000E+00 | 0.000000E+00 | | | | | |
| Y**6 | −1.235056E−08 | 0.000000E+00 | 3.012763E−11 | 0.000000E+00 | −3.844346E−14 | | | | | | |
| Y**7 | 0.000000E+00 | 0.000000E+00 | 0.000000E+00 | 0.000000E+00 | | | | | | | |
| Y**8 | 8.210326E−12 | 0.000000E+00 | −1.623513E−14 | | | | | | | | |
| Y**9 | 0.000000E+00 | 0.000000E+00 | | | | | | | | | |
| Y**10 | −3.090747E−15 | | | | | | | | | | |

On the upper side of the following Table 16, regarding the first reflective surface R1 and the second reflective surface R2 of the prism according to each of Numerical Examples 1 to 3, the numerical values of the major diameter A of the footprint of the first principal light ray closest to the optical axis OA, the major diameter B of the footprint of the second principal light ray farthest from the optical axis OA, and the ratio B/A of both are shown.

The lower part of the following Table 16 shows the numerical values of the minimum incident angle, the maximum incident angle, the refractive index of the prism, and the critical angle for the first reflective surface R1 and the second reflective surface R2 of the prism according to each of Numerical Examples 1 to 3.

TABLE 16

| | A: Major axis of footprint of light ray | | B: Major axis of footprint of light ray | | | |
|---|---|---|---|---|---|---|
| | closest to optical axis | | farthest from optical axis | | B/A | |
| | First reflective | Second reflective | First reflective | Second reflective | First reflective | Second reflective |
| | surface | surface | surface | surface | surface | surface |
| Example 1 | 0.46 | 0.75 | 2.23 | 5.63 | 4.8 | 7.5 |
| Example 2 | 2.01 | 3.65 | 2.86 | 18.74 | 1.4 | 5.1 |
| Example 3 | 1.52 | 2.38 | 2.54 | 14.01 | 1.7 | 5.9 |

| | | Minimum | Maximum | | |
|---|---|---|---|---|---|
| | | incident angle | incident angle | Refractive index | Critical angle |
| Example 1 | First reflective | 16.7 | 39.0 | 1.69384 | 36.2 |
| | surface | | | | |
| | Second reflective | 10.9 | 77.1 | 1.69384 | 36.2 |
| | surface | | | | |
| Example 2 | First reflective | 9.0 | 44.9 | 1.58913 | 39.0 |
| | surface | | | | |
| | Second reflective | 23.2 | 64.6 | 1.58913 | 39.0 |
| | surface | | | | |
| Example 3 | First reflective | 2.0 | 39.2 | 1.58913 | 39.0 |
| | surface | | | | |
| | Second reflective | 3.1 | 66.6 | 1.58913 | 39.0 |
| | surface | | | | |

### Second Embodiment

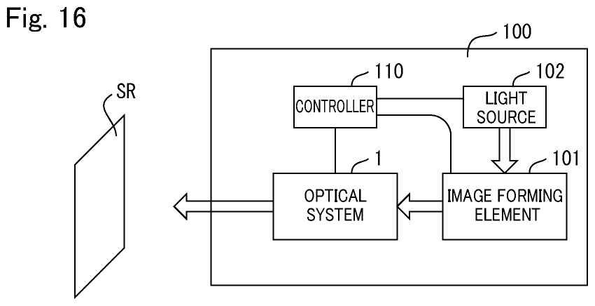

Hereinafter, a second embodiment of the present disclosure will be described with reference to FIG. 16. FIG. 16 is a block diagram illustrating an example of an image projection apparatus according to the present disclosure. The image projection apparatus 100 includes the optical system 1 disclosed in the first embodiment, an image forming element 101, a light source 102, a controller 110, and the like. The image forming element 101 includes a liquid crystal, a DMD, and the like, and generates an image to be projected onto the screen SR via the optical system 1. The light source 102 includes a light emitting diode (LED), a laser, and the like, and supplies light to the image forming element 101. The controller 110 includes a CPU, or an MPU, and the like, and controls the entire device and each component. The optical system 1 may be configured as an interchangeable lens detachably attachable to the image projection apparatus 100, or may be configured as a built-in lens integrated with the image projection apparatus 100.

In the image projection apparatus 100 described above, the optical system 1 according to the first embodiment enables projection of a short focal and a large screen with a small device.

As described above, the embodiments have been described as the disclosure of the technique in the present disclosure. For this purpose, the accompanying drawings and the detailed description have been provided.

Therefore, the components described in the accompanying drawings and the detailed description may include not only components essential for solving the problem but also components that are not essential for solving the problem in order to exemplify the above technique. Therefore, it should not be immediately recognized that these non-essential components are essential on the basis of the fact that these non-essential components are described in the accompanying drawings and the detailed description.

In addition, since the above-described embodiments are intended to exemplify the technique in the present disclosure, various changes, replacements, additions, omissions, and the like can be made within the scope of the claims and equivalents thereof.

What is claimed is:

1. A projection optical system having a reduction conjugate point on a reduction side and a magnification conjugate point on a magnification side, and having an intermediate imaging position being conjugate with the reduction conjugate point and the magnification conjugate point inside, and the projection optical system into which red light, green light, and blue light are incident from a light source, and which projects an image, the projection optical system comprising:
a first sub-optical system; and
a second sub-optical system disposed closer to the magnification side than the first sub-optical system,
wherein
the first sub-optical system includes a plurality of lenses,
the second sub-optical system includes a prism formed of a transparent medium,
the prism includes: a first transmission surface located closest to the first sub-optical system on an optical path between the first sub-optical system and the magnification conjugate point; a second transmission surface located closest to the magnification conjugate point; and a reflective surface group including a second reflective surface located closest to the second transmission surface on the optical path between the first transmission surface and the second transmission surface,
all or a part of the intermediate imaging position is present inside the prism,
the second reflective surface is formed with a dielectric multilayer film including no metal layer, and
a reflectance of the dielectric multilayer film. is larger than 95% with respect to the blue light.

2. The projection optical system according to claim 1, wherein an average reflectance of S-polarized light and P-polarized light of the dielectric multilayer film is larger than 95% with respect to incident light having a wavelength in a range of 440 nm or more and 480 nm or less, which is within a wavelength range of the blue light at an incident angle between an angle smaller than a critical angle by 5 degrees or less and the critical angle.

3. The projection optical system according to claim 2, wherein an average reflectance of S-polarized light and P-polarized light of the dielectric multilayer film has a ripple in which the average reflectance of S-polarized light and P-polarized light is 95% or less with respect to incident light having a wavelength in a range of more than 480 nm and 510 nm or less, the wavelength being between a peak wavelength of the blue light and a peak wavelength of the green light, at an incident angle between an angle smaller than a critical angle by 5 degrees or less and the critical angle.

4. The projection optical system according to claim 1, wherein
the reflective surface group includes a first reflective surface and the second reflective surface in order from a reduction side on the optical path,
an absolute value of an optical power of the first reflective surface is larger than an absolute value of an optical power of the second reflective surface,
a footprint of the second reflective surface is smaller than a footprint of the first reflective surface, and
the dielectric multilayer film is formed on both of the first reflective surface and the second reflective surface, or only on the second reflective surface.

5. The projection optical system according to claim 1, wherein the intermediate imaging position is located between the first transmission surface and the reflective surface group.

6. The projection optical system according to claim 1, wherein B≥3×A is satisfied where A is a major diameter of a footprint of a first principal light ray on the second reflective surface, the first principal light ray being closest to an optical axis of the first sub-optical system, and B is a major diameter of a footprint of a second principal light ray on the second reflective surface, the second principal light ray being farthest from the optical axis.

7. The projection optical system according to claim 1, wherein the second reflective surface reflects both a first light ray having an incident angle at which total reflection is performed and a second light ray having an incident angle at which total reflection is not performed.

8. The projection optical system according to claim 1, wherein the second reflective surface has a shape such that a light ray having an incident angle of 25° or more and 60° or less with respect to a normal line of an incident surface of each light ray traveling on the second reflective surface is incident on the second reflective surface.

9. The projection optical system according to claim 1, wherein an air layer is present on a back surface of an effective area of the second reflective surface, and the prism is in contact with an external member in a region other than the back surface of the effective area of the second reflective surface.

10. The projection optical system according to claim 1, wherein an air layer having a thickness of 5 mm or more is present on a back surface of an effective area of the second reflective surface.

11. The projection optical system according to claim 1, wherein the dielectric multilayer film includes 54 or more layers having different refractive indexes, the layers being alternately stacked.

12. The projection optical system according to claim 1, wherein the dielectric multilayer film has an extinction coefficient of 0.1 or less at normal temperature with respect to incident light having a wavelength of 632.8 nm, which is the red light.

13. The projection optical system according to claim 1, wherein the dielectric multilayer film is constituted by alternately stacking a high refractive index layer having a refractive index of 2.0 or more and a low refractive index layer having a refractive index of 1.6 or less.

14. The projection optical system according to claim 11, wherein the second reflective surface has a reflectance of 95% or more with respect to incident light having a wavelength of 450 to 850 nm at normal incidence with the dielectric multilayer film, the incident light including the red light, the green light and the blue light.

15. The projection optical system according to claim 1, wherein the prism is made of glass.

16. The projection optical system according to claim 1, wherein the projection optical system projects light of 3000 lumens or more.

17. The projection optical system according to claim 1, wherein a protective layer is formed on the second reflective surface on a side opposite to the prism of the dielectric multilayer film.

18. A projection optical system having a reduction conjugate point on a reduction side and a magnification conjugate point on a magnification side, and having an intermediate imaging position being conjugate with the reduction conjugate point and the magnification conjugate point inside, and the projection optical system into which red light, green light, and blue light are incident from a light source, and which projects an image, the projection optical system comprising:
a first sub-optical system; and
a second sub-optical system disposed closer to the magnification side than the first sub-optical system,
wherein
the first sub-optical system includes a plurality of lenses,
the second sub-optical system includes a prism formed of a transparent medium,
the prism includes: a first transmission surface located closest to the first sub-optical system on an optical path between the first sub-optical system and the magnification conjugate point; a second transmission surface located closest to the magnification conjugate point; and a reflective surface group including a second reflective surface located closest to the second transmission surface on the optical path between the first transmission surface and the second transmission surface,
all or a part of the intermediate imaging position is present inside the prism,
the second reflective surface is formed with a coating layer that reflects both a first light ray having an incident angle at which total reflection is performed and a second light ray having an incident angle at which total reflection is not formed, and
a reflectance of the coating layer film. is larger than 95% with respect to the blue light.

19. The projection optical system according to claim 18, wherein the coating layer is formed on all the reflective surfaces of the reflective surface group.

20. An image projection apparatus comprising:
the projection optical system according to claim 1;
an image forming element that generates an image to be projected onto a screen via the projection optical system; and
a light source that supplies light to the image forming element.
